(19) United States
(12) Patent Application Publication
(10) Pub. No.: US 2024/0051733 A1
(43) Pub. Date: Feb. 15, 2024

(54) WELDING WIRE CONTAINERS AND SUPPORT MEMBER THEREFOR

(71) Applicant: ESAB AB, Gothenburg (SE)

(72) Inventors: Claes Gimström, Gothenburg (SE); Roberto Carlos Guerrero Kees, Frisco, TX (US); Gerard F. Klaes, Moab, UT (US); Rodolfo F. Rep, Hanover, PA (US); Mikael Mimer, Gothenburg (SE); Michael Guion, Mechanicsburg, PA (US); Cliff Campell, Irving, TX (US); Mathankumar Jawahar, Fremont, CA (US)

(21) Appl. No.: 18/492,893

(22) Filed: Oct. 24, 2023

Related U.S. Application Data
(63) Continuation of application No. PCT/IB2022/000256, filed on Apr. 28, 2022.
(60) Provisional application No. 63/182,121, filed on Apr. 30, 2021.

(51) Int. Cl. B65D 85/04; B65D 5/50

(52) U.S. Cl. CPC B65D 85/04; B65D 5/5033

(57) ABSTRACT

A container for housing a welding wire that includes an outer sleeve and at least one support member. The outer sleeve of the container may define an interior cavity. The outer sleeve of the container may be in the shape of an irregular octagonal prism. The at least one support member may be disposed within the interior cavity of the outer sleeve. The at least one support member may also extend vertically through the interior cavity of the outer sleeve. The at least one support member may be in the shape of a trapezoidal prism. With the at least one support member disposed within the interior cavity of the outer sleeve, the at least one support member and the outer sleeve collectively define a region of the interior cavity of the first sleeve that has a regular octagonal shaped cross-section.

### CROSS-REFERENCE TO RELATED APPLICATIONS

This application claims priority to and is a continuation of International Patent Application Ser. No. PCT/IB2022/000256, entitled “WELDING WIRE CONTAINERS AND SUPPORT MEMBER THEREFOR”, filed Apr. 28, 2022, which claims priority under 35 U.S.C. 119(e) to U.S. Provisional Patent Application Ser. No. 63/182,121, entitled “WELDING WIRE PACKAGING”, filed Apr. 30, 2021, and the disclosure of each of those two applications is incorporated herein by reference in its entirety for all purposes.

### FIELD OF THE INVENTION

The present invention relates to packaging for welding wire and, in particular, bulk welding wire packaging.

### BACKGROUND OF THE INVENTION

Welding wire for automatic or semi-automatic welding processes is often provided in bulk in the form of a coil. For transportation and storage of the welding wire coil, a welding wire container is used which has two primary functions. First, the welding wire container may serve as a means for transporting the welding wire coil and for protecting it during transportation. The welding wire container may also serve as a delivery device that allows continuous withdrawal of the welding wire from the coil within the welding wire container.

Conventional welding wire containers may have an outer sleeve or jacket that may be primarily constructed from cardboard, and may have an outer shape of a rectangular prism or cuboid. By constructing the outer sleeve from cardboard, and giving the outer sleeve this shape, the corners of the outer sleeve may require structural supports disposed within the corners of the outer sleeve to both retain the welding wire coil within the container (i.e., to serve as radial supports or abutment supports for the welding wire coil within the container). Because of the structural requirements of these structural supports, these structural supports are often constructed from materials that are not able to be easily recycled, which creates waste after consumption of the bulk welding wire coil. In addition, despite the structural supports, the rectangular prism shape of the outer sleeve, and ultimately the container, may further limit the size of the welding wire coil that may be disposed within the interior of the container.

The object of the present invention is to improve upon the conventional welding wire containers to provide a welding wire container that is nearly entirely recyclable, while also being able to house a welding wire coil that is larger/heavier than those typically housed by conventional welding wire containers.

### SUMMARY OF THE INVENTION

The present invention is directed to a container for housing a welding wire. The container may include an outer sleeve and at least one support member. The outer sleeve may define an interior cavity. The at least one support member may be disposed within the interior cavity of the outer sleeve, and may extend vertically through the interior cavity of the outer sleeve. The at least one support member may be in the shape of a trapezoidal prism.

The at least one support member may include a first side, a second side, a third side, and a fourth side, where the first side is parallel to the second side, and where the first side is wider in width than the second side. The third side and the fourth side of the at least one support member may connect the first side to the second side. In addition, the at least one support member may include a central rib that extends between the first side and the second side.

Furthermore, the outer sleeve may have an irregular octagonal prism shape that includes four first sides and four second sides. The four first sides may be wider than each of the four second sides. The outer sleeve may alternate between the first sides and the second sides along the perimeter of the outer sleeve. The at least one support member may include four support members, and each support member of the four support members may be disposed within the interior cavity of the outer sleeve such that the second side of each of the support members is disposed against one of the second sides of the outer sleeve. Moreover, the interior cavity of the outer sleeve may be a first interior cavity, and the container may further include an inner sleeve disposed within the first interior cavity of the outer sleeve. The inner sleeve may define a second interior cavity. The inner sleeve may be a regular octagonal prism.

The present invention is further directed to a support member for a welding wire container, where the support member may have an unfolded orientation and a folded orientation. In the unfolded orientation, the support member may be planar. In the folded orientation, the support member may have a trapezoidal prism shape. When in the folded orientation, the support member may have a first side, a second side, a third side, and a fourth side. The first side may have a first width, while the second side may have a second width. The first width may be greater than the second width. Furthermore, the second side may be parallel to, and spaced from, the first side. The third side and the fourth side may couple the first side to the second side. The third side and the fourth side may be offset from being parallel to the first and second sides. The third side and the fourth side may also be offset from being perpendicular to the first and second sides.

The support member in the unfolded orientation may include a first outer segment, a second outer segment opposite the first outer segment, and a central segment disposed between the first outer segment and the second outer segment. The support member in the unfolded orientation may further include a first set of intermediate segments disposed between the first outer segment and the central segment, and a second set of intermediate segments disposed between the second outer segment and the central segment. The first outer segment may include a first opening and the second outer segment may include a second opening. The central segment may include a first repositionable tab and a second repositionable tab. When reconfiguring the support member from the unfolded orientation to the folded orientation, the first outer segment may be folded along the first set of intermediate segments such that the first outer segment may be disposed proximate to the central segment where the first opening of the first outer segment aligns with the first repositionable tab of the central segment. Furthermore, when reconfiguring the support member from the unfolded orientation to the folded orientation, the second outer segment may also be folded along the second set of intermediate segments such that the second outer segment may be disposed proximate to the central segment where the second opening of the second outer segment aligns with the second repositionable tab of the central segment.

Additionally, when the support member is in the folded orientation, the support member may further include a central rib that extends between the first side and the second side. The central rib may be disposed equidistant from the third side and the fourth side of the support member. The support member in the folded orientation may further include a first tubular channel and a second tubular channel. The first tubular channel may be collectively defined by at least a portion of the first side, a portion of the second side, the third side, and the central rib. Similarly, the second tubular channel may be collectively defined by at least a portion of the first side, a portion of the second side, the fourth side, and the central rib. Moreover, the support member may be constructed from corrugated fiberboard materials.

In addition, the present invention is also directed to a container configured to house a bulk welding wire coil, where the container includes a first sleeve and at least one support member. The first sleeve may have an irregular octagonal prism shape, and may define an interior cavity. The at least one support member may be disposed within the interior cavity of the first sleeve, and may extend vertically through the interior cavity of the first sleeve. The at least one support member may be shaped and located within the interior cavity of the first sleeve such that the at least one support member and the first sleeve collectively define a region of the interior cavity of the first sleeve that has a regular octagonal shaped cross-section.

The container may further include a second sleeve that may have a regular octagonal prism shape that may be disposed within the region of the interior cavity of the first sleeve. The at least one support member may include four support members, and each of the four support members may be a trapezoidal prism. The first sleeve and the at least one support member may be constructed from corrugated fiberboard materials.

### BRIEF DESCRIPTION OF THE DRAWINGS

FIGS. 1A-1D illustrate perspective views to the welding wire container according to an embodiment of the present invention.

FIGS. 2A and 2B illustrate perspective views of an outer sleeve of the welding wire container illustrated in FIGS. 1A-1D.

FIGS. 3A-3D illustrate various folding steps for forming the outer sleeve, as illustrated in FIGS. 2A and 2B, of the welding wire container illustrated in FIGS. 1A-1D.

FIG. 4 illustrates a top view of the outer sleeve of the welding wire container illustrated in FIGS. 2A and 2B, the top view depicting the interior of the outer sleeve.

FIGS. 5A and 5B illustrate front and rear views of a support member of the welding wire container illustrated in FIGS. 1A-1D.

FIGS. 6A-6E illustrate various folding steps for forming one of the support members, as illustrated in FIGS. 5A and 5B, of the welding wire container illustrated in FIGS. 1A-1D.

FIG. 7 illustrates a perspective view of four of the support members, as illustrated in FIGS. 5A and 5B at least partially inserted into the outer sleeve, as illustrated in FIGS. 2A and 2B, of the welding wire container illustrated in FIGS. 1A-1D.

FIG. 8 illustrates a perspective view of a bag of the welding wire container illustrated in FIGS. 1A-1D.

FIG. 9 illustrates a perspective view of the bag illustrated in FIG. 8 inserted into the interior cavity of the outer sleeve, as illustrated in FIGS. 2A and 2B, of the welding wire container illustrated in FIGS. 1A-1D.

FIGS. 10A and 10B illustrate perspective views of an inner sleeve of the welding wire container illustrated in FIGS. 1A-1D.

FIG. 11 illustrates a perspective view of the inner sleeve illustrated in FIGS. 10A and 10B being inserted into the interior of the cavity of the bag illustrated in FIG. 8.

FIGS. 12A-12C illustrate views of a bottom inner panel of the welding wire container illustrated in FIGS. 1A-1D.

FIG. 13 illustrates a top perspective view of the outer sleeve illustrated in FIGS. 2A and 2B, where the bottom inner panel illustrated in FIGS. 12A-12C is inserted into the interior cavity of the inner sleeve illustrated in FIGS. 10A and 10B, which is inserted into the bag illustrated in FIG. 8, which is inserted into the interior cavity of the outer sleeve illustrated in FIGS. 2A and 2B.

FIG. 14 illustrates a top view of the outer sleeve illustrated in FIGS. 2A and 2B, where the support members illustrated in FIGS. 5A and 5B and the inner sleeve illustrated in FIGS. 10A and 10B are disposed within the interior cavity of the outer sleeve illustrated in FIGS. 2A and 2B, and where the bottom inner panel illustrated in FIGS. 12A-12C is placed within the interior cavity of the inner sleeve.

FIGS. 15A and 15B illustrate perspective views of a lid of the welding wire container illustrated in FIGS. 1A-1D.

FIG. 16 illustrates an exploded view of the welding wire container illustrated in FIGS. 1A-1D.

FIG. 17 illustrates a cross-sectional view taken along line X-X of the welding wire container illustrated in FIG. 1A.

FIG. 18 illustrates a cross-sectional view taken along line Y-Y of the welding wire container illustrated in FIG. 1A.

FIG. 19A-19C illustrates a various views of the welding wire container illustrated in FIGS. 1A-1D, where a bulk welding wire coil is disposed and secured within the welding wire container.

FIG. 20 illustrates a perspective view of the welding wire container illustrated in FIGS. 1A-1D being disposed on a pallet.

FIGS. 21A and 21B illustrate front and rear perspective views of a hood of the welding wire container illustrated in FIGS. 1A-1D.

FIG. 21C illustrates a perspective view of the welding wire container illustrated in FIGS. 1A-1D with the hood illustrated in FIGS. 21A and 21B disposed on the welding wire container.

Like reference numerals have been used to identify like elements throughout this disclosure.

### DETAILED DESCRIPTION OF THE INVENTION

The present invention is directed to a container for housing a welding wire that includes an outer sleeve and at least one support member. The outer sleeve of the container may define an interior cavity. The outer sleeve of the container may be in the shape of an irregular octagonal prism. The at least one support member may be disposed within the interior cavity of the outer sleeve. The at least one support member may also extend vertically through the interior cavity of the outer sleeve. The at least one support member may have an unfolded orientation, where the at least one support member is planar, and a folded orientation, where the at least one support member may be in the shape of a trapezoidal prism. With the at least one support member disposed within the interior cavity of the outer sleeve, the at least one support member and the outer sleeve collectively define a region of the interior cavity of the first sleeve that has a regular octagonal shaped cross-section. The outer sleeve and the at least one support member may each be constructed from corrugated fiberboard materials. This shape and construction of the container enables the container to house larger/heavier welding wire coils, while also reducing the amount of waste created from the container (i.e., the majority of the parts may be recycled).

In the following detailed description, reference is made to the accompanying figures which form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the description herein. Alternate embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The terms “comprising,” “including,” “having,” and the like, as used with respect to embodiments of the present disclosure, are synonymous.

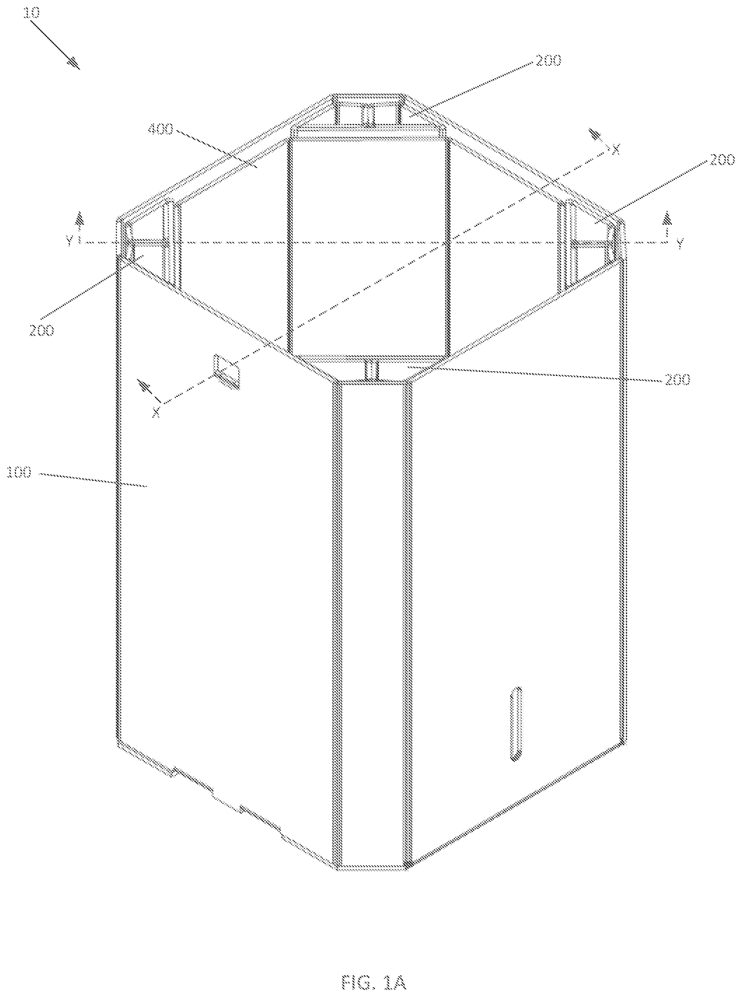

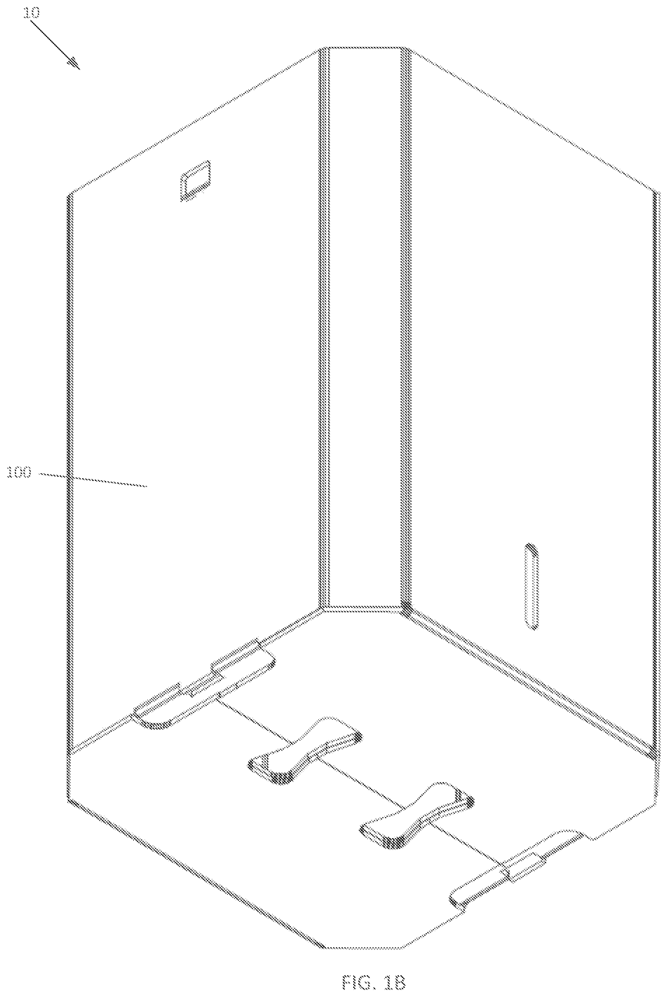

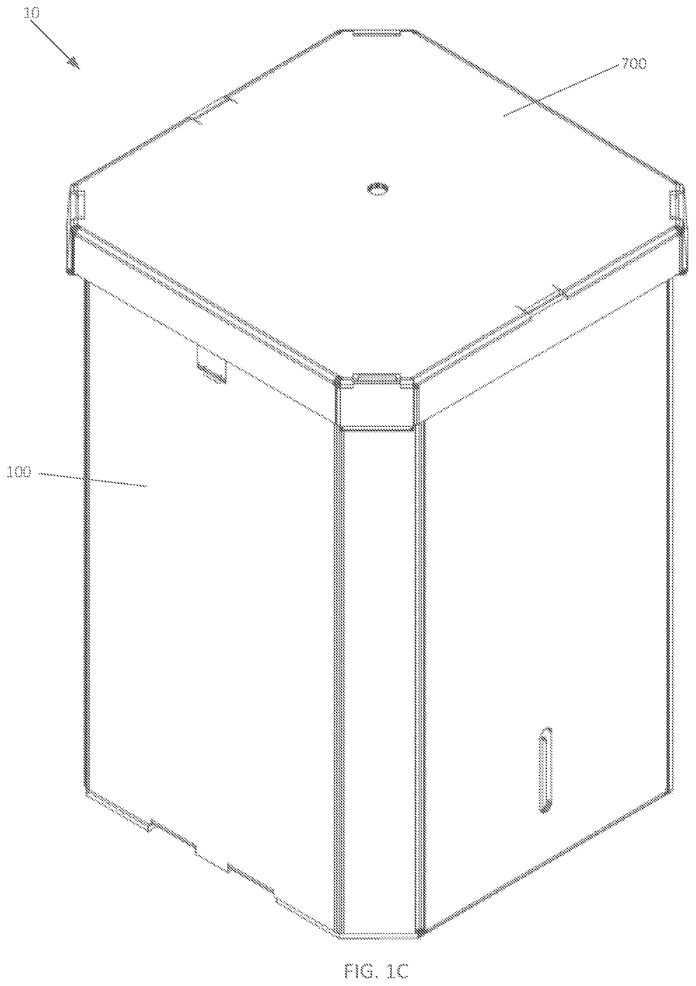

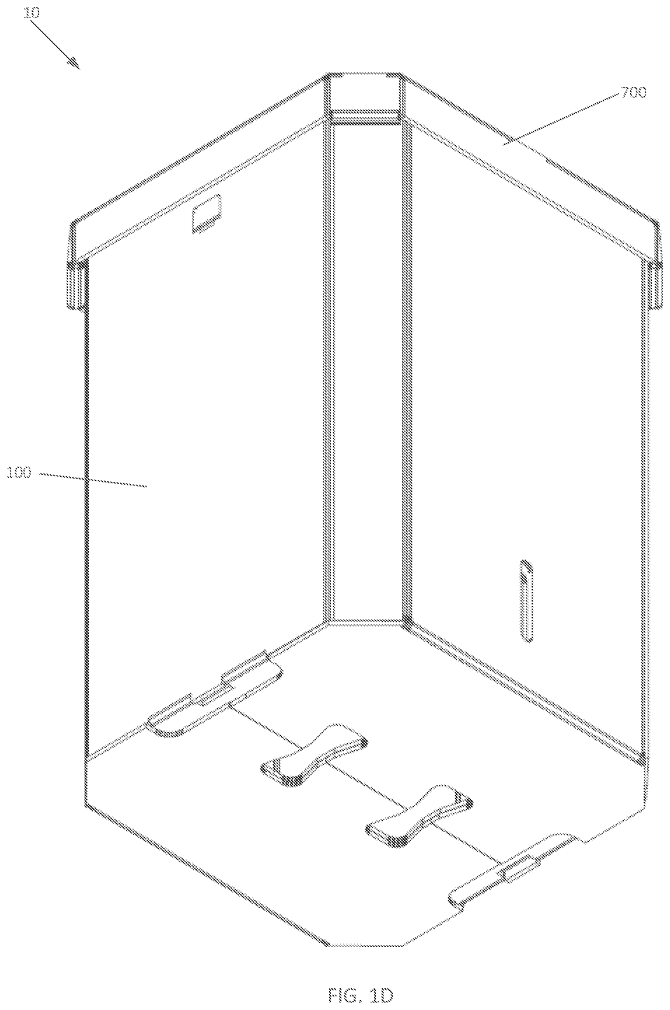

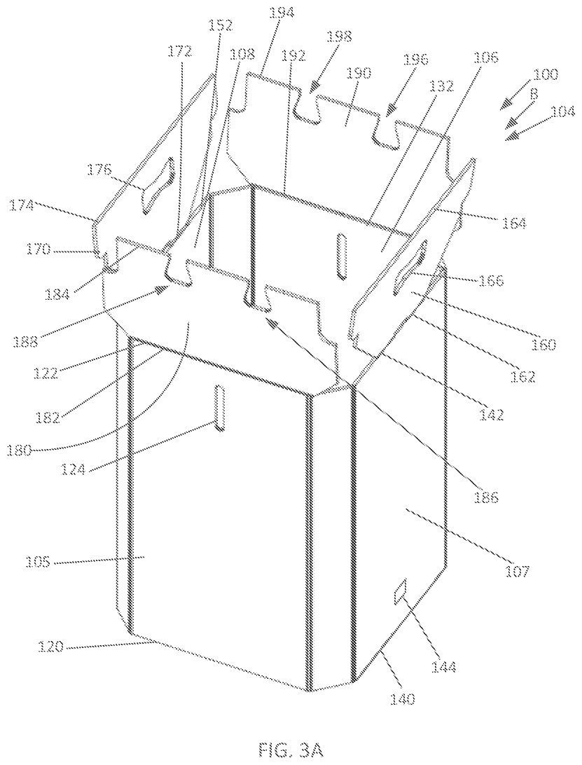

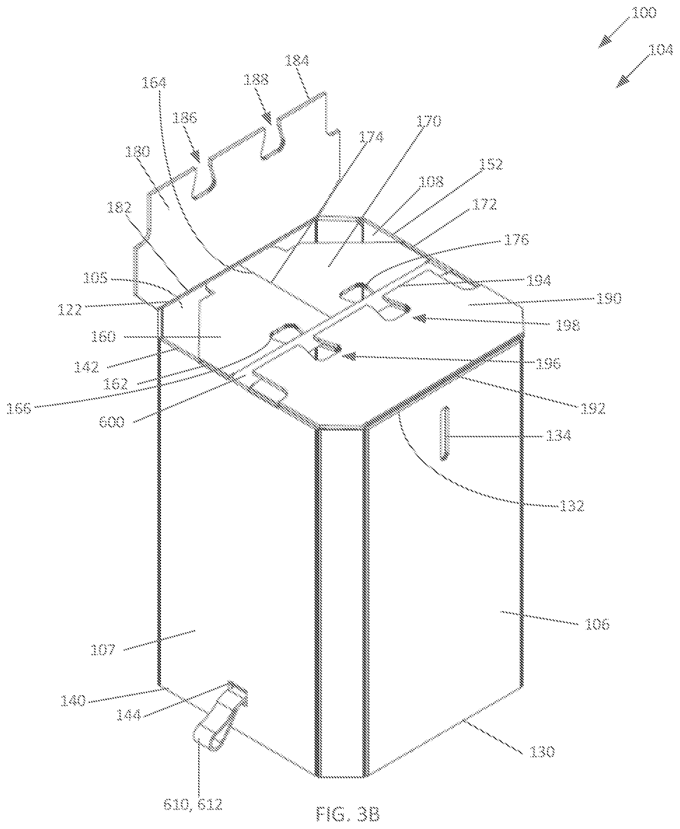

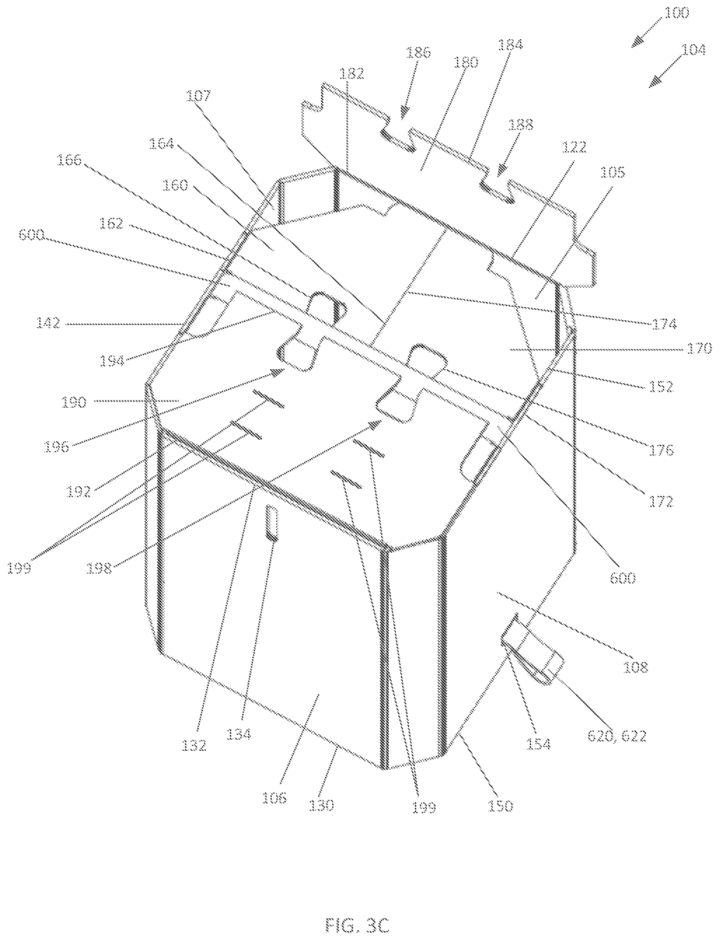

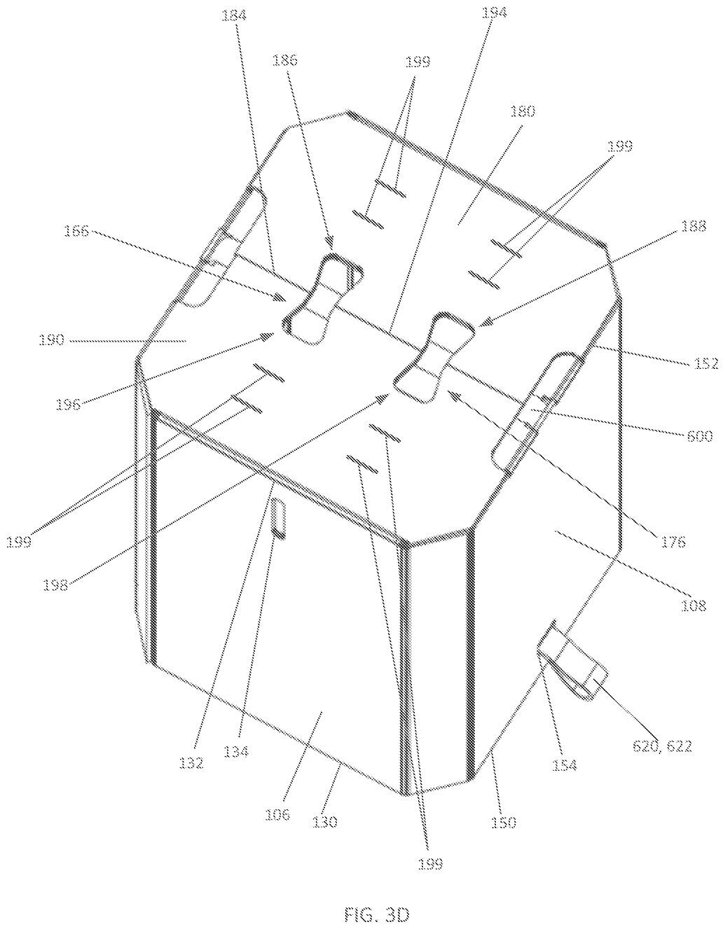

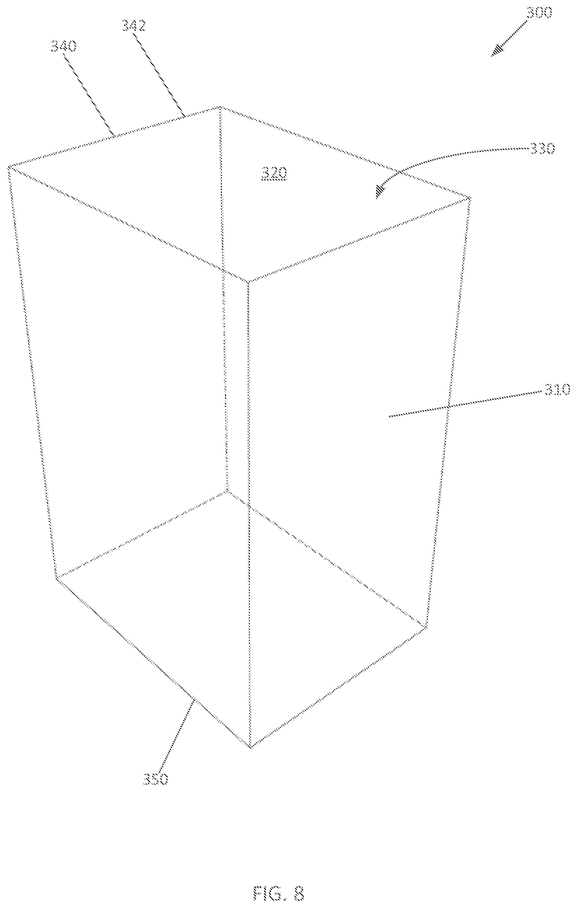

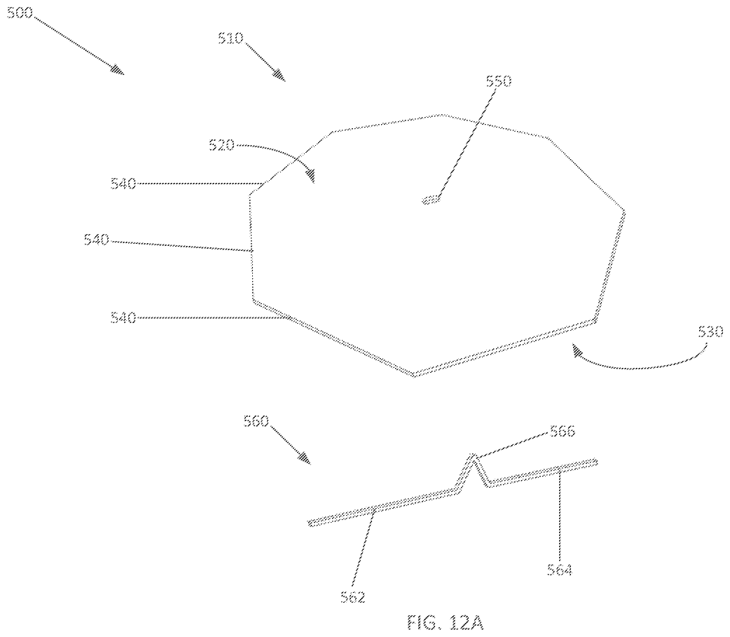

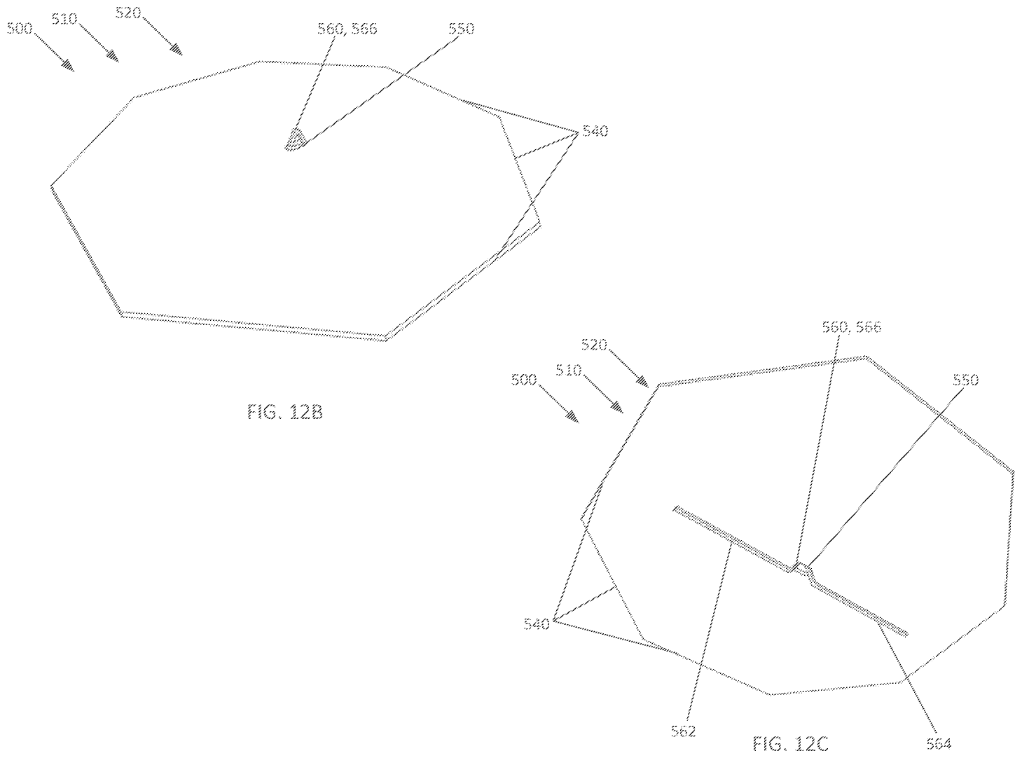

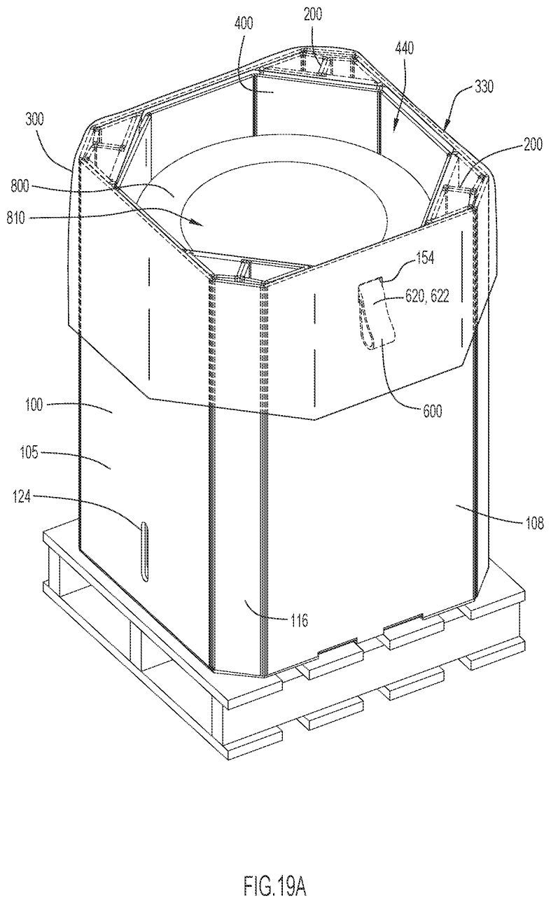

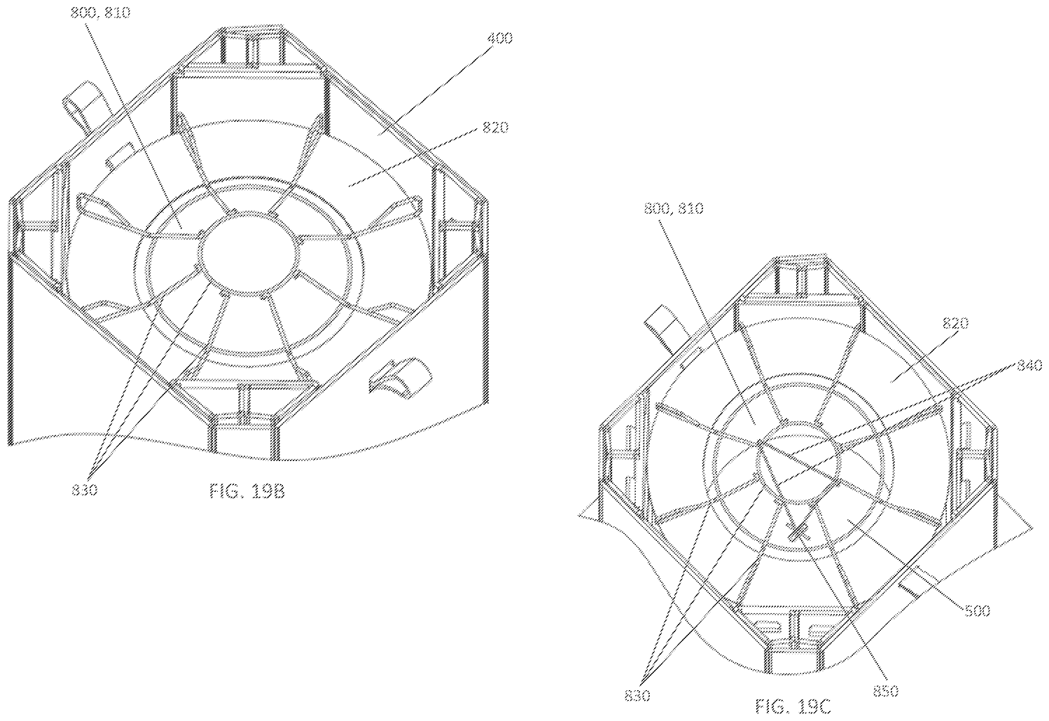

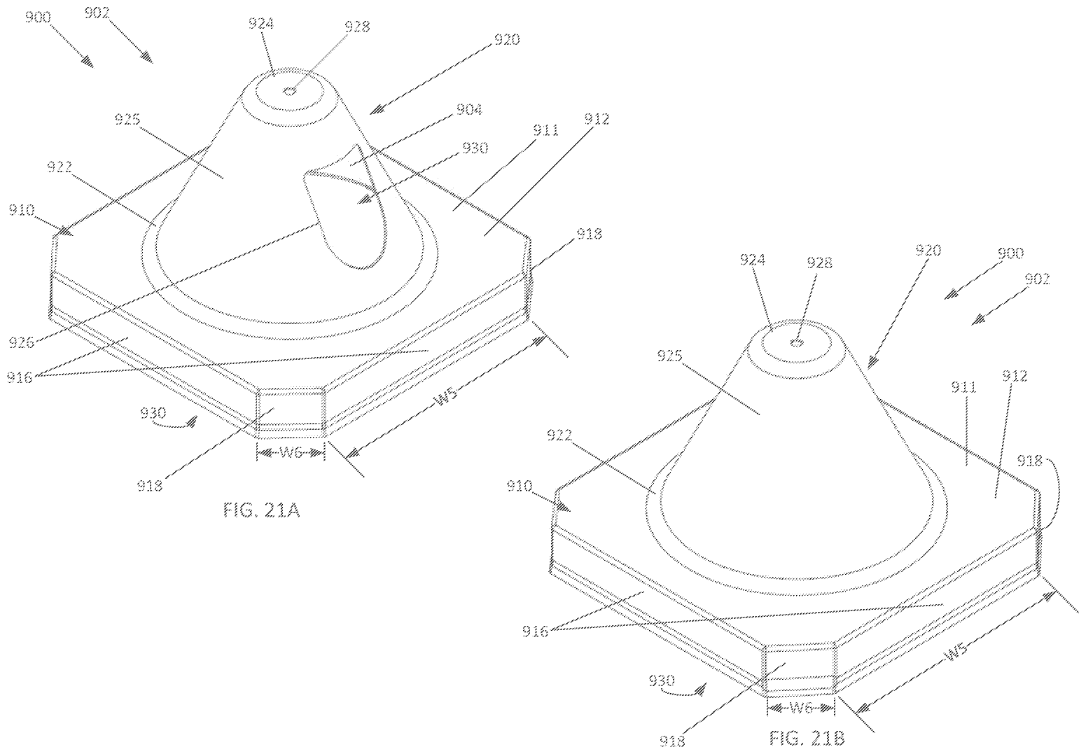

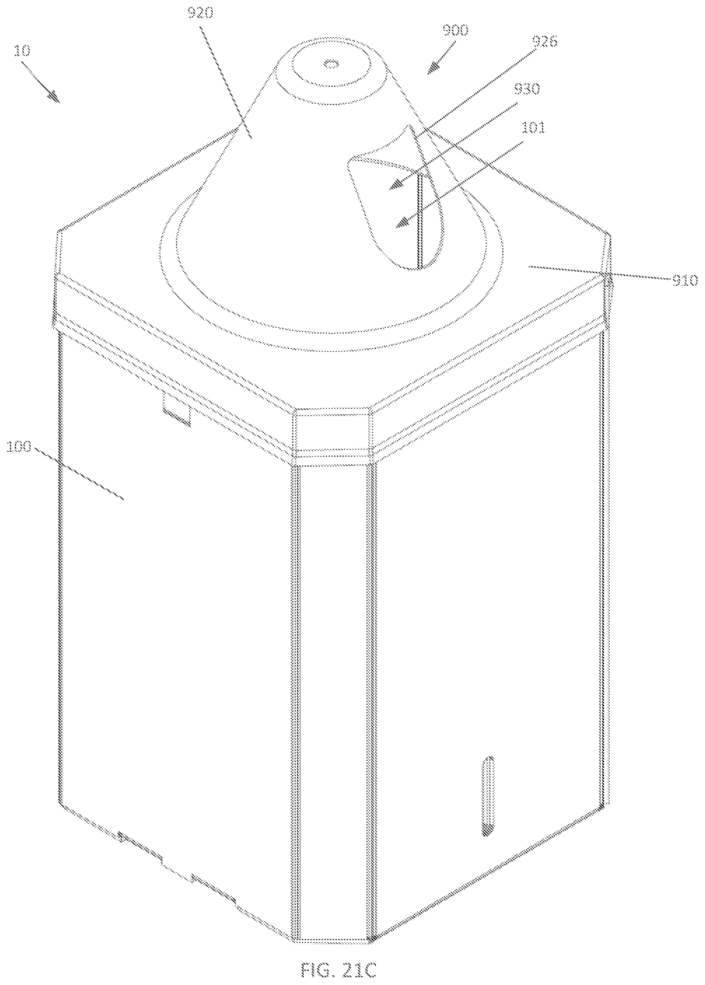

With general reference to FIGS. 1A-1D, a bulk welding wire container 10 for storing and dispensing a bulk welding wire coil is shown. The welding wire container 10 illustrated in FIGS. 1A-1D may be an irregular octagonal prism. The welding wire container 10 may include a plurality of components, including, but not limited to, an outer sleeve 100, multiple support members 200, a bag 300 (best shown in FIGS. 8 and 9), an inner sleeve 400, a bottom inner panel 500 (best shown in FIGS. 12A-12C, 13, and 14), a strap 600 (best shown in FIGS. 3A-3D), and a lid 700 or hood 900 (best illustrated in FIGS. 21A-21C). These components may be combined with one another to form the welding wire container 10 so that the welding wire container 10 can house and dispense a bulk welding wire coil 800 (best illustrated in FIG. 19A).

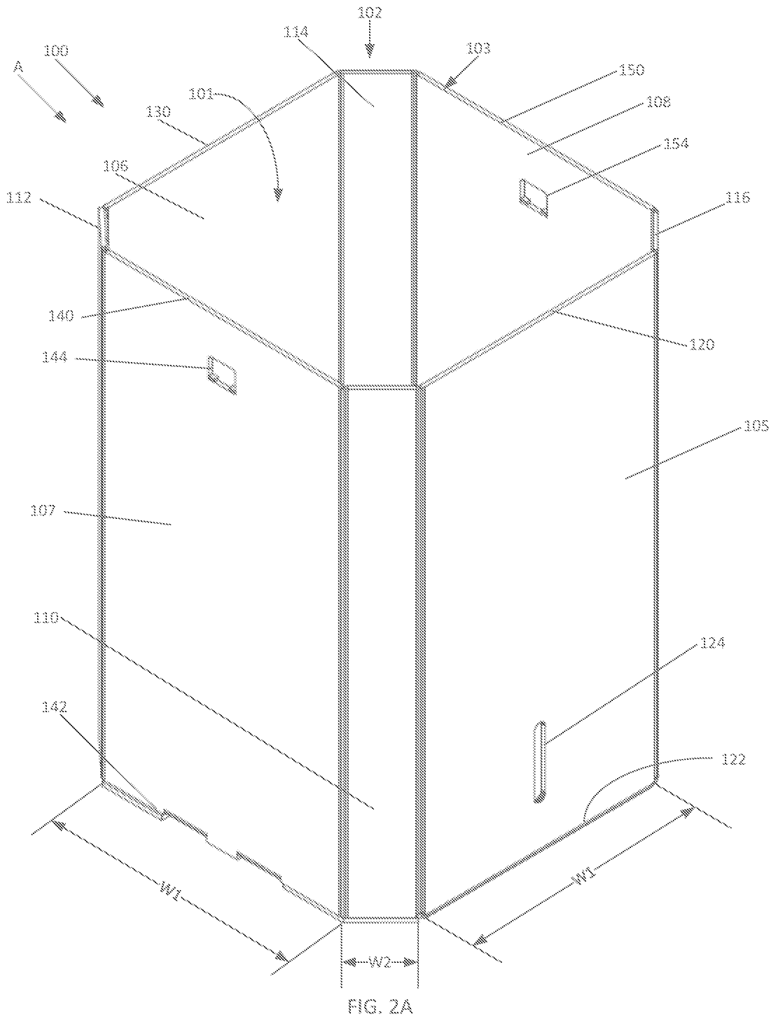

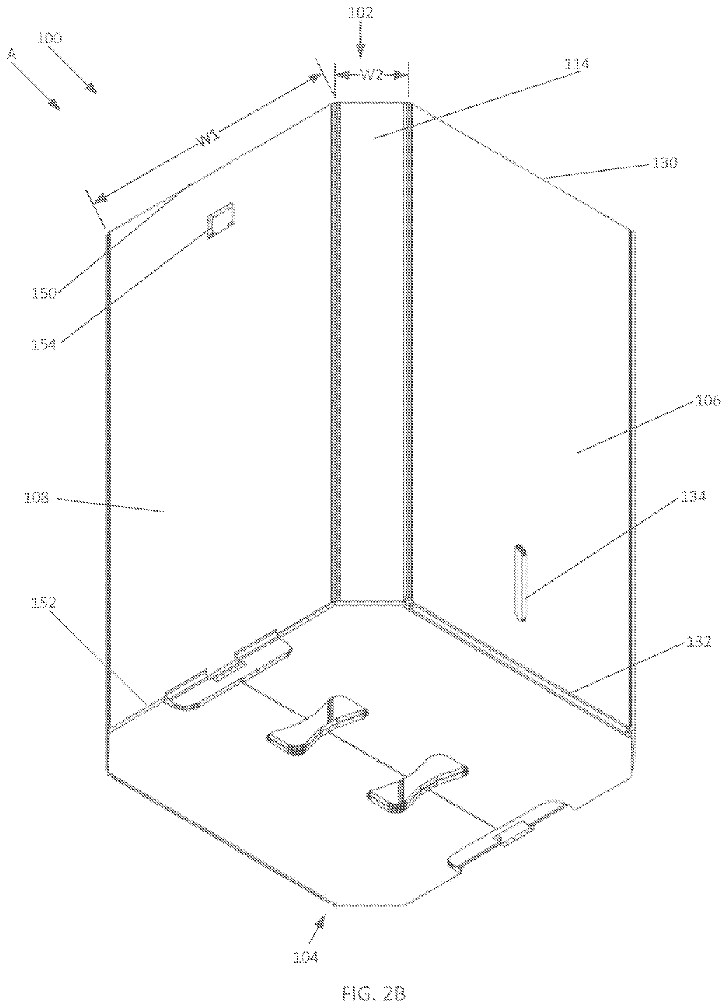

Turning to FIGS. 2A and 2B, illustrated is the outer sleeve 100 of the welding wire container 10. The outer sleeve 100 may in the shape of an irregular octagonal prism that is constructed from, but not limited to, corrugated fiberboard materials. The outer sleeve 100 may include a top side 102 and an opposite bottom side 104. As illustrated, the outer sleeve 100 further includes four wide side panels 105, 106, 107, 108 having a first width W1, and four thin side panels 110, 112, 114, 116 having a second width W2, where the first width W1 is larger than the second width W2. The first width W1 and the second width W2 may be defined as a measured horizontal distance across a side 105, 106, 107, 108, 110, 112, 114, 116 of the outer sleeve 100 (i.e., such that the measured distance is parallel to the top and bottom sides 102, 104). The wide side panels 105, 106, 107, 108 being wider than the thin side panels 110, 112, 114, 116 gives the outer sleeve 100, and ultimately the welding wire container 10, the irregular octagonal prism shape. As further illustrated in FIGS. 2A and 2B, the wide side panels 105, 106, 107, 108 and thin side panels 110, 112, 114, 116 may be oriented in an alternating pattern around the perimeter of the outer sleeve 100 such that a thin side panel 110, 112, 114, 116 is disposed between two wide side panels 105, 106, 107, 108, and vice versa.

The first panel 105 of the wide side panels may include a top end 120 and an opposite bottom end 122, where the top end 120 is disposed proximate to the top side 102 of the outer sleeve 100 and the bottom end 122 disposed proximate to the bottom side 104 of the outer sleeve 100. As further illustrated, the first panel 105 of the wide side panels includes an elongated opening 124 disposed more proximate to the bottom end 122 than the top end 120. The second panel 106 of the wide side panels, which is oriented opposite of the first panel 105 of the wide side panels, may include a top end 130 and an opposite bottom end 132, where the top end 130 is disposed proximate to the top side 102 of the outer sleeve 100 and the bottom end 132 is disposed proximate to the bottom side 104 of the outer sleeve 100. As further illustrated, the second panel 106 of the wide side panels also includes an elongated opening 134 disposed more proximate to the bottom end 132 than the top end 130. The elongated opening 134 of the second panel 106 may be aligned laterally with the elongated opening 124 of the first panel 105.

The third panel 107 of the wide side panels may include a top end 140 and an opposite bottom end 142, where the top end 140 is disposed proximate to the top side 102 of the outer sleeve 100 and the bottom end 142 disposed proximate to the bottom side 104 of the outer sleeve 100. As further illustrated, the third panel 107 of the wide side panels includes a rectangular or stadium shaped opening 144 disposed more proximate to the top end 140 than the bottom end 142. The fourth panel 108 of the wide side panels, which is oriented opposite of the third panel 107 of the wide side panels, may include a top end 150 and an opposite bottom end 152, where the top end 150 is disposed proximate to the top side 102 of the outer sleeve 100 and the bottom end 152 disposed proximate to the bottom side 104 of the outer sleeve 100. As further illustrated, the fourth panel 108 of the wide side panels also includes a rectangular or stadium shaped opening 154 disposed more proximate to the top end 150 than the bottom end 152. The opening 154 of the fourth panel 108 may be aligned laterally with the opening 144 of the third panel 107.

The outer sleeve 100 illustrated in FIGS. 2A and 2B is shown in the folded position A, while FIG. 3A illustrates the outer sleeve 100 in the unfolded position B. As illustrated in FIGS. 3A-3D, and with continued reference to FIGS. 2A and 2B, illustrated are the various steps for transitioning the outer sleeve 100 from the unfolded position B to the folded position A. As best illustrated in FIG. 3A, the bottom side 104 of the outer sleeve 100 includes a first bottom panel 160, a second bottom panel 170, a third bottom panel 180, and a fourth bottom panel 190. The first bottom panel 160 includes a first end 162 and an opposite second end 164, where the first end 162 is hingedly coupled to the bottom end 142 of the third panel 107 of the wide side panels. The first bottom panel 160 further includes an opening 166 disposed between the first and second ends 162, 164. Similarly, the second bottom panel 170 includes a first end 172 and an opposite second end 174, where the first end 172 is hingedly coupled to the bottom end 152 of the fourth panel 108 of the wide side panels. Like the first bottom panel 160, the second bottom panel 170 further includes an opening 176 disposed between the first and second ends 172, 174. The openings 166, 176 of the first and second bottom panels 160, 170, respectively, may have a generally hourglass shape.

The third bottom panel 180 and the fourth bottom panel 190 are different from the first and second bottom panels 160, 170, while being substantially identical to one another. The third bottom panel 180 includes a first end 182 and an opposite second end 184, where the first end 182 is hingedly coupled to the bottom end 122 of the first panel 105 of the wide side panels. The second end 184 of the third bottom panel 180 further includes two depressions or cutouts 186, 188. Similar to the third bottom panel 180, the fourth bottom panel 190 includes a first end 192 and an opposite second end 194, where the first end 192 is hingedly coupled to the bottom end 132 of the second panel 106 of the wide side panels. The second end 194 of the fourth bottom panel 190, like that of the third bottom panel 180, further includes two depressions or cutouts 196, 198.

As best illustrated in FIG. 3B, when transitioning the outer sleeve 100 from the unfolded position B to the folded position A, the first and second bottom panels 160, 170 are folded toward one another. More specifically, the first bottom panel 160 is folded along the coupling of the first end 162 to the bottom end 142 of the third panel 107 of the wide side panels, while the second bottom panel 170 is folded along the coupling of the first end 172 to the bottom end 152 of the fourth panel 108 of the wide side panels. The first and second bottom panels 160, 170 are folded along their respective fold lines toward one another such that the first and second bottom panels 160, 170 are oriented substantially perpendicular to the side panels 105, 106, 107, 108, 110, 112, 114, 116. When the first and second bottom panels 160, 170 are folded toward one another, the second end 164 of the first bottom panel 160 is disposed proximate to, adjacent to, or in abutment with, the second end 174 of the second bottom panel 170.

Once the first and second bottom panels 160, 170 are folded toward one another, the strap 600 may be affixed to the outer sleeve 100. As further illustrated in FIG. 3B and FIG. 3C, the strap 600, which includes a first end 610 and a second end 620, may be positioned across the first and second bottom panels 160, 170 such that the strap 600 is oriented substantially transverse to the second ends 164, 174 of the first and second bottom panels 160, 170, respectively. As further illustrated in FIGS. 3B and 3C, the strap 600 spans across the openings 166, 176 of the first and second bottom panels 160, 170, respectively. The strap 600 may be further configured to extend along the inner side of the third and fourth panels 107, 108 of the wide side panels of the outer sleeve 100 such that the first end 610 of the strap 600 is threaded through the opening 144 of the third panel 107 (as shown in FIG. 3B) and the second end 620 of the strap 600 is threaded through the opening 154 of the fourth panel 108 (as shown in FIG. 3C). This orientation is further illustrated in FIG. 4. The first end 610 of the strap 600 may include a first handle 612, while the second end 620 of the strap 600 may include a second handle 622. The first and second handles 612, 622 may be formed by looping a portion of the strap 600 back across itself and affixing the ends of the strap 600 to itself in order to form loops. In other embodiments, the handles 612, 622 may be formed in another manner, such as, but not limited to, securing a handle member (e.g., constructed from plastic) to the ends 610, 620 of the strap 600.

Returning to FIGS. 3B-3D, once the strap 600 is extended over the first and second bottom panels 160, 170, the third bottom panel 180 and the fourth bottom panel 190 are folded toward one another such that the third and fourth bottom panels 180, 190 cover the first and second bottom panels 160, 170. More specifically, the third bottom panel 180 is folded along the coupling of the first end 182 to the bottom end 122 of the first panel 105 of the wide side panels, while the fourth bottom panel 190 is folded along the coupling of the first end 192 to the bottom end 132 of the second panel 106 of the wide side panels. The third and fourth bottom panels 180, 190 are folded along their respective fold lines toward one another such that the third and fourth bottom panels 180, 190 are oriented substantially perpendicular to the side panels 105, 106, 107, 108, 110, 112, 114, 116. When the third and fourth bottom panels 180, 190 are folded toward one another, the second end 184 of the third bottom panel 180 is disposed proximate to, adjacent to, or in abutment with, the second end 194 of the fourth bottom panel 190. Moreover, the second ends 184, 194 of the third and fourth bottom panels 180, 190, respectively extend across both the first and second bottom panels 160, 170, as well as along the strap 600. Furthermore, when the second end 184 of the third bottom panel 180 is disposed proximate to the second end 194 of the fourth bottom panel 190, the cutouts 186, 188 of the third bottom panel 180 are disposed adjacent to the cutouts 196, 198 of the fourth bottom panel 190 such that the cutouts 186 and 196 collectively form an opening aligned with the opening 166 of the first bottom panel 160, and the cutouts 188 and 198 collectively form an opening aligned with the opening 176 of the second bottom panel 170. Thus, the cutouts 186 and 196 collectively form an opening having a generally hourglass shape, while the cutouts 188 and 198 also collectively form an opening having a generally hourglass shape.

When the third and fourth bottom panels 180, 190 are folded toward one another, the strap 600 is sandwiched or disposed between the combination of the third and fourth bottom panels 180, 190 and the combination of the first and second bottom panels 160, 170. As best illustrated in FIG. 3D, when the third and fourth bottom panels 180, 190 are folded toward one another, the third and fourth bottom panels 180, 190 may be secured to the first and second bottom panels 160, 170 via a fastener or series of fasteners 199. In the embodiment illustrated in FIG. 3D, the fasteners 199 may be stables. In other embodiments, the fasteners 199 may include, but are not limited to, clips, nails, screws, pins, adhesives, tabs/slots formed in the bottom panels 160, 170, 180, 190 themselves, etc. The generally hourglass shape of the openings on the bottom panels 160, 170, 180, 190 facilitate receiving or insertion of a stapler to apply the fasteners 199 to the bottom panels 160, 170, 180, 190.

As best illustrated in FIG. 4, once the outer sleeve 100 is in the folded position A, the wide side panels 105, 106, 107, 108, the thin side panels 110, 112, 114, 116, and the bottom side 104 collectively define an interior cavity 101. The interior cavity 101 may be accessible via the opening 103 of the top side 102 of the outer sleeve 100. As further explained below, the interior cavity 101 may be configured to house multiple additional components 200, 300, 400, 500, 600 of the welding wire container 10, as well as a bulk welding wire coil 800.

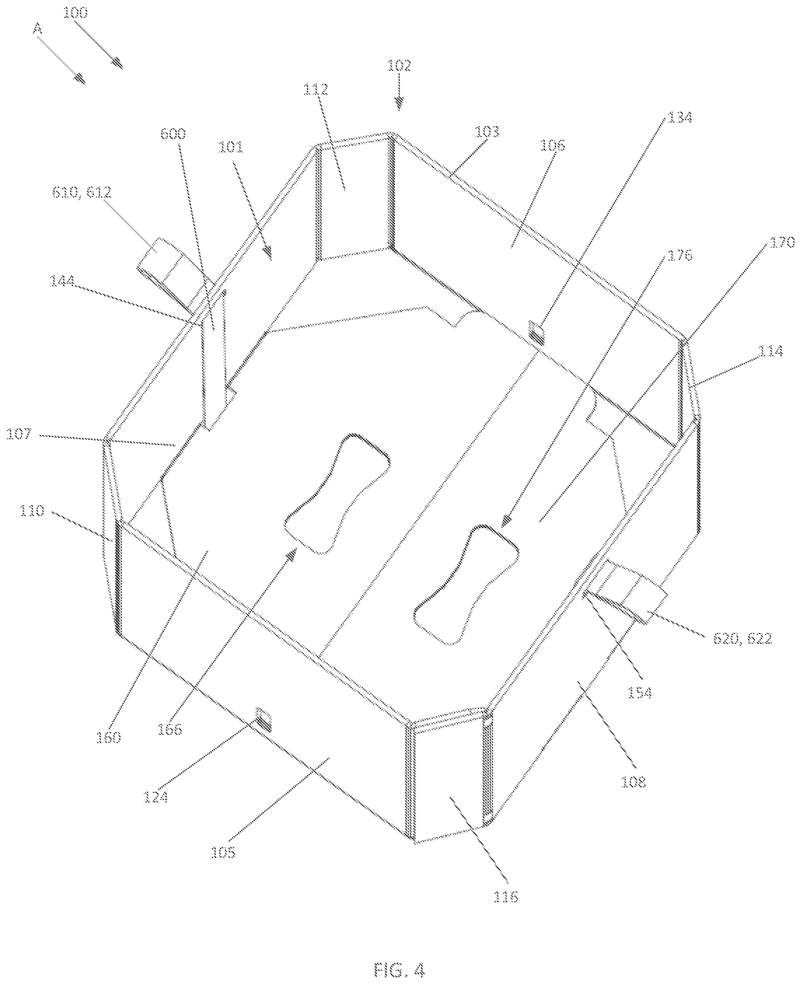

Turning to FIGS. 5A and 5B, illustrated is an embodiment of a support member 200 of the welding wire container 10. While only one support member 200 is illustrated in FIGS. 5A and 5B, the welding wire container 10 may include a plurality of support members 200 that are all substantially identical to one another, and that are identical to the support member 200 illustrated in FIGS. 5A and 5B. As illustrated, the support member 200 includes a first or distal end 210 and a second or proximal end 212 opposite the distal end 210. The support member 200 may be constructed from, but not limited to, corrugated fiberboard materials. The support member 200 may have a substantially trapezoidal cross-section such that the support member 200 contains four sides 220, 230, 240, 242. Thus, the support member 200 may be in the shape of a trapezoidal prism. The first side 220 and the second side 230 may be parallel to one another, where the first side 220 may be wider than the second side 230. The third and fourth sides 240, 242 may be angled with respect to the first and second sides 220, 230, and may connect the ends of the first side 220 with the ends of the second side 230 to form the trapezoidal cross-section shape of the support member 200. Further connecting the first side 220 to the second side 230 is a central rib 250 that is oriented substantially perpendicular to the first and second sides 220, 230. The central rib 250 may be spaced equidistantly from the third and fourth sides 240, 242 such that a first tubular channel 252 is collectively defined by a portion of the first side 220, a portion of the second side 230, the third side 240, and the central rib 250, and a second tubular channel 254 is collectively defined by another portion of the first side 220, another portion of the second side 230, the fourth side 242, and the central rib 250. As illustrated, the sides 220, 230, 242, the central rib 250, and the tubular channels 252, 254 extend along the length of the support member 200 between the distal end 210 and the proximal end 212.

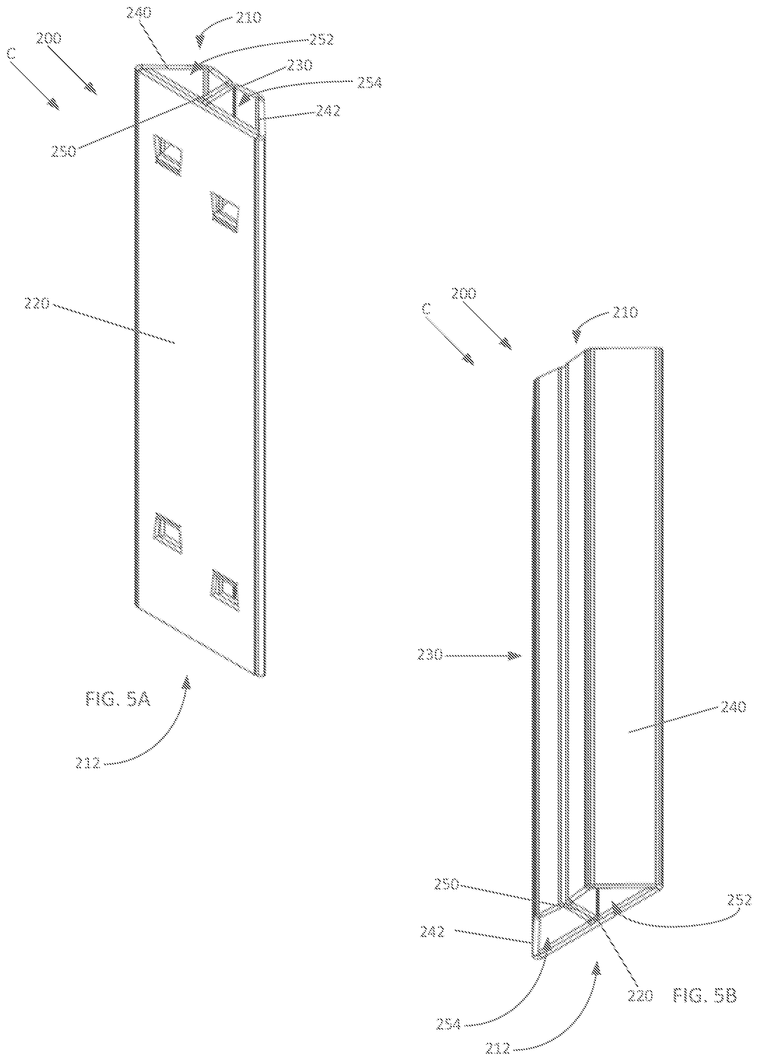

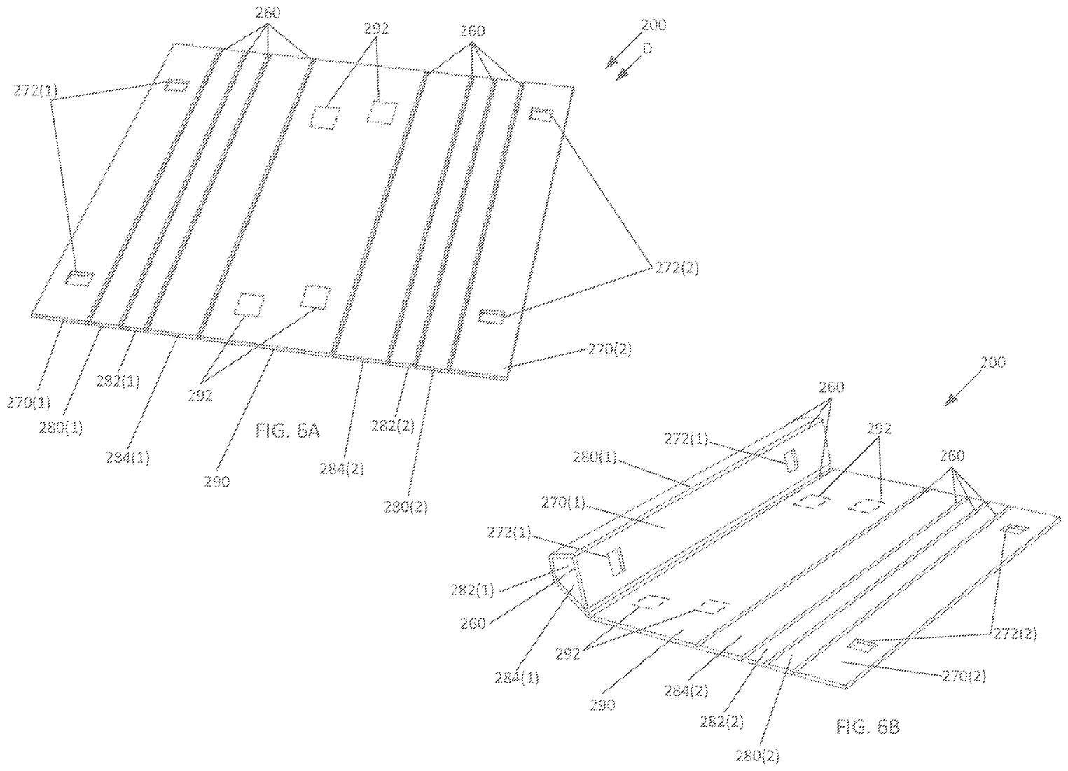

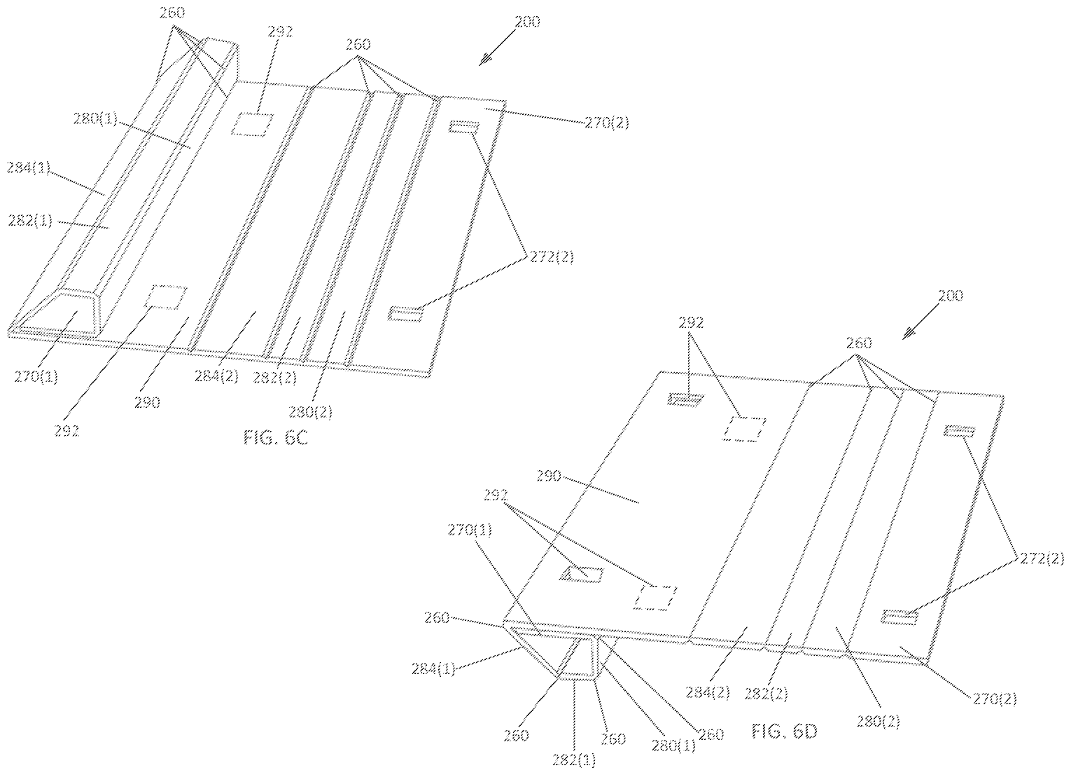

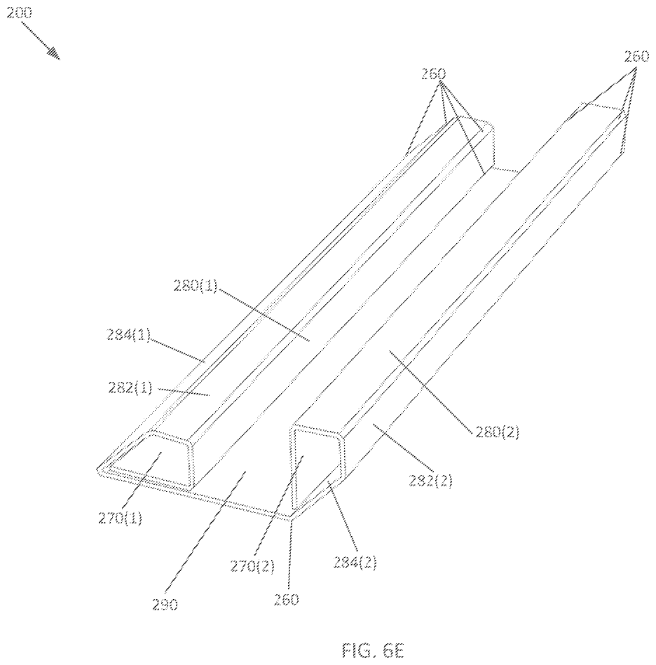

The support member 200 illustrated in FIGS. 5A and 5B is shown in the folded position C, while FIG. 6A illustrates the support member 200 in the unfolded position D. As illustrated in FIGS. 6A-6E, and with continued reference to FIGS. 5A and 5B, illustrated are the various steps for transitioning the support member 200 from the unfolded position D to the folded position C. As best illustrated in FIG. 6A, support member 200, when in the unfolded position D has a substantially planar rectangular shape. The support member 200 in the unfolded position D may contain a series of elongated segments 270, 280, 282, 284, 290 spanning from the distal end 210 of the support member 200 to the proximal end 212 of the support member 200. As illustrated in FIG. 6A, the support member 200 in the unfolded position D includes two outer segments 270(1), 270(2), collectively referred to as 270. The support member 200 further includes two first intermediate segments 280(1), 280(2), collectively referred to as 280, two second intermediate segments 282(1), 282(2), collectively referred to as 282, and two third intermediate segments 284(1), 284(2), collectively referred to as 284. The support member 200 also includes a central segment 290. As further illustrated in FIG. 6A, the outer segment 270(1), first intermediate segment 280(1), second intermediate segment 282(1), and third intermediate segment 284(1) are disposed on one side of the central segment 290, while outer segment 270(2), first intermediate segment 280(2), second intermediate segment 282(2), and third intermediate segment 284(2) are disposed on the opposing side of the central segment 290. Moreover, fold lines 260 are disposed between each of the outer segments 270, the first intermediate segments 280, the second intermediate segments 282, the third intermediate segments 284, and the central segment 290.

FIG. 6A further illustrates that each of the outer segments 270 include a pair of openings 272 (which collectively includes openings 272(1) on the first outer segment 270(1) and openings 272(2) on the second outer segment 270(2)). The central segment 290 further includes a series of repositionable tabs or padlocks 292. In FIG. 6A, the padlocks 292 are disposed within the plane of the central segment 290. Moreover, the second intermediate segments 282 are thinner in width than the first intermediate segments 280 and the third intermediate segments 284, while the first intermediate segments 280 are thinner in width than the third intermediate segments 284. As further illustrated, the outer segments 270 may be wider than the intermediate segments 280, 282, but the third intermediate segments 284 may be wider than or equal in width to the outer segments 270. Moreover, the central segment 290 may be wider than each of the outer segments 270 and intermediate segments 280, 282, 284.

As illustrated in FIGS. 6B-6D, outer segment 270(1), first intermediate segment 280(1), second intermediate segment 282(1), and third intermediate segment 284(1) are folded with respect to each other, and with respect to the central segment 290, along their respective fold lines 260 such that the outer segment 270(1) is folded toward the central segment 290 until the outer segment 270(1) is disposed proximate to, adjacent to, or in contact with, the central segment 290. More specifically, outer segment 270(1) is folded approximately 90 degrees along a fold line 260 with respect to the first intermediate segment 280(1) such that the outer segment 270(1) is oriented substantially perpendicular to the first intermediate segment 280(1). The combination of the outer segment 270(1) and the first intermediate segment 280(1) are then together folded approximately 90 degrees along a fold line 260 with respect to the second intermediate segment 282(1) such that the first intermediate segment 280(1) is oriented substantially perpendicular to the second intermediate segment 282(1), and such that the outer segment 270(1) is spaced from, and oriented substantially parallel to, the second intermediate segment 282(1). As further illustrated in FIG. 6B, the outer segment 270(1), the first intermediate segment 280(1), and the second intermediate segment 282(1) are then together folded along a fold line 260 with respect to the third intermediate segment 284(1) such that the free end of the outer segment 270(1) is disposed proximate to the fold line 260 between the third intermediate segment 284(1) and the central segment 290. As best illustrated in FIGS. 6B and 6C, the outer segment 270(1), the first intermediate segment 280(1), the second intermediate segment 282(1), and the third segment 284(1) are then together folded along a fold line 260 such that the outer segment 270(1) is disposed against the central segment 290 and the first intermediate segment 280(1) is oriented perpendicular to the central segment 290. As further illustrated in FIG. 6C, the second intermediate segment 282(1) is spaced from, but oriented parallel to, the central segment 290, while the third intermediate segment 284(1) is oriented at an angle with respect to the outer segment 270(1), first intermediated segment 280(1), second intermediate segment 282(1), and central segment 290 such that the third intermediate segment 284(1) is neither parallel to, nor perpendicular to, the outer segment 270(1), first intermediated segment 280(1), second intermediate segment 282(1), and central segment 290. As best illustrated in FIG. 6D, when the outer segment 270(1) is disposed adjacent or proximate to the central segment 290, the openings 272(1) of the outer segment 270(1) are aligned with two of the padlocks 292 of the central segment 290. Two of the padlocks 292 may then be repositioned (e.g., folded out of plane from the central segment 290) such that two of the padlocks 292 are disposed within the openings 272(1). The padlocks 292 may be larger in size than the openings 272(1) such that, when the padlocks 292 are repositioned to be disposed within the openings 272(1), the outer segment 270(1) is secured to the central segment 290. As illustrated in FIG. 6E, once outer segment 270(1) is secured to the central segment 290, outer segment 270(2), first intermediate segment 280(2), second intermediate segment 282(2), and third intermediate segment 284(2) are folded along their respective fold lines 260, and in a similar manner, so that the outer segment 270(2) may be positioned in abutment with, and secured to, the central segment 290 proximate to outer segment 270(1) (i.e., such that the openings 272(2) of the outer segment 270(2) are aligned with two of the padlocks 292 of the central segment 290, and such that two of the padlocks 292 are repositioned to be disposed within the openings 272(2)).

As further illustrated in FIGS. 5A, 5B, and 6A-6E, when the support member 200 is in the folded position C, the central segment 290 forms the first side 220 of the support member 200, and the second intermediate segments 282 collectively form the second side 230 of the support member 200. The outer segments 270 may provide additional support to the central segment 290 as the first side 220 of the support member 200 may be formed of two layers (e.g., one layer formed by the outer segments 270, the other layer formed by the central segment 290). Moreover, third intermediate segment 284(1) may form the third side 240 and the fourth intermediate segment 284(2) may form the fourth side 242 of the support member 200. Furthermore, the second intermediate segments 282 collectively form the central rib 250 of the support member 200. The first tubular channel 252 may be defined by outer segment 270(1), first intermediate segment 280(1), second intermediate segment 282(1), and third intermediate segment 284(1), while the second tubular channel 254 may be defined by outer segment 270(2), first intermediate segment 280(2), second intermediate segment 282(2), and third intermediate segment 284(2).

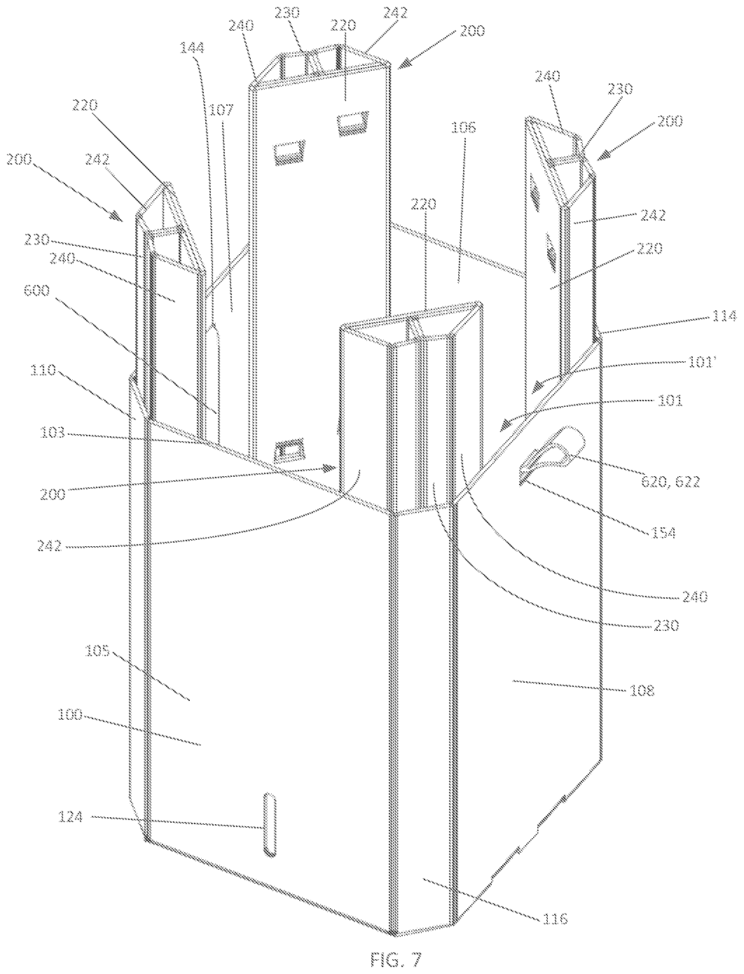

Turning to FIG. 7, illustrated is a perspective view of the outer sleeve 100 with four support members 200 being inserted into the interior cavity 101 of the outer sleeve 100 via the opening 103 on the top side 102 of the outer sleeve 100. As illustrated, each support member 200 is positioned in a respective “corner” of the outer sleeve 100, where the term corner is defined by the coupling of two wide side panels 105, 106, 107, 108 to one of the thin side panels 110, 112, 114, 116. Thus, the four support members 200 may be disposed within the interior cavity 101 of the outer sleeve 100 such that the second side 230 of each support member 200 is disposed against, adjacent to, or proximate to a thin side panel 110, 112, 114, 116. Moreover, the third and fourth sides 240, 242 of each support member 200 may extend partially along respective wide side panels 105, 106, 107, 108. For example, one support member 200 may be disposed within the interior cavity 101 of the outer sleeve 100 such that the second side 230 of the support member 200 is disposed against thin side panel 110, such that third side 240 of the support member 200 extends along the fourth panel 108 of the wide side panels, and such that the fourth side 242 of the support member 200 extends along the first panel 105 of the wide side panels. As further explained below, while the outer sleeve 100 has a cross-sectional shape of an irregular octagon, which defines the interior cavity 101 of the outer sleeve 100 as having an irregular octagon, when the support members 200 are disposed within the interior cavity 101 of the outer sleeve 100, the resulting sub-region 101′ of the interior cavity 101 has a regular octagon shape. The sub-region 101′ of the interior cavity 101 may be collectively defined by the first sides 220 of the support members 200 and portions of the wide side panels 105, 106, 107, 108 that are disposed, and exposed, between support members 200.

Turning to FIG. 8, illustrated is a wrapper or bag 300. The embodiment of the bag 300 illustrated in FIG. 8 may be a rectangular prism, but other embodiments of the bag 300 may be of any other shape (e.g., octagonal prism, cylindrical prism, etc.). The bag 300 may contain an exterior surface 310 and an interior surface 320. The interior surface 320 of the bag 300 may define an interior cavity 330. The bag 300 may further include a first or top end 340 and an opposite second or bottom end 350. As illustrated in FIG. 8, the top end 340 of the bag 300 may include an opening 342 through which the interior cavity 330 may be accessed.

As illustrated in FIG. 9, and with continued reference to FIG. 8, the bag 300 may be inserted into the interior cavity 101 of the outer sleeve 100 such that the support members 200 are disposed outside of the bag 300. As explained in further detail below, with the bag 300 disposed within the interior cavity 101 of the outer sleeve 100, the inner sleeve 400 and the bulk welding wire coil 800, along with other components of the welding wire container 10, may be disposed within the interior cavity 330 of the bag 300. As further illustrated in FIG. 9, the bag 300 may be taller in height than the outer sleeve 100 and the support members 200 such that an excess length or amount at the top end 340 of the bag 300 may be extended over at least a welding wire coil disposed within the interior cavity 330 of the bag 300. The excess length of the bag 300 may be tied off so that the interior cavity 330 of the bag 300 may be effectively sealed from moisture ingression while the welding wire container 10 is in storage and/or transit, as well as in use at a worksite. Isolation of the welding wire coil from the environment is needed so moisture does not affect the wire surface of the welding wire core. Moisture exposure (i.e., from a humid environment) may affect diffusible hydrogen results in the welded material, which may negatively affect the final weld properties.

In some embodiments, the bag 300 may be constructed from a moisture impermeable barrier material (e.g., such as metal foils and metallized polymers). In other embodiments, the bag 300 may be constructed from polyethylene (sometimes referred to as a “poly bag”). While poly bags do not serve as a moisture impermeable barrier, they may slow the rate of moisture ingression as a means of preventing the formation of rust on a welding wire coil disposed within the interior cavity 330 of the bag 300.

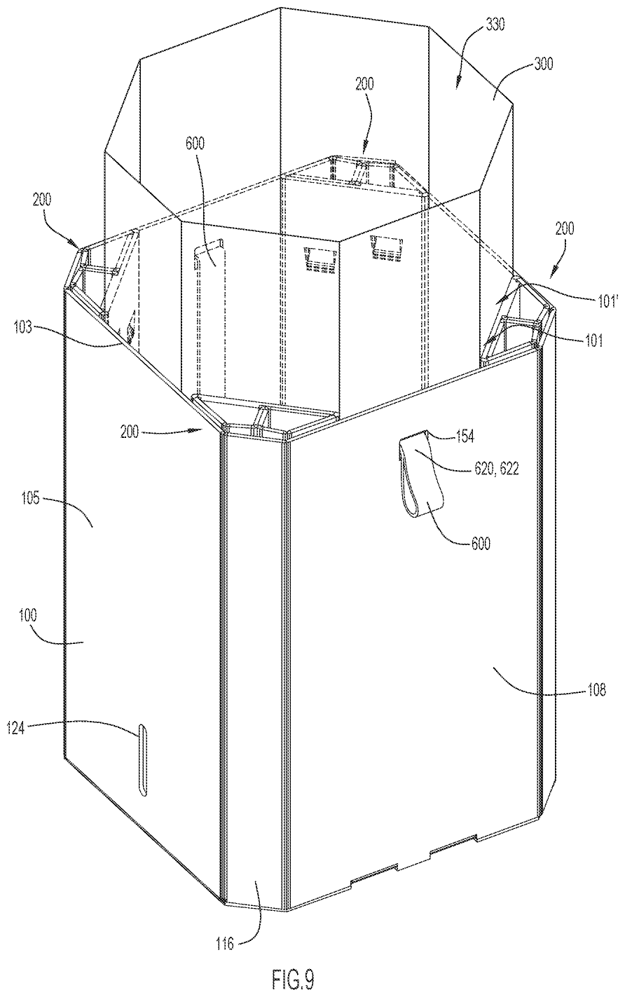

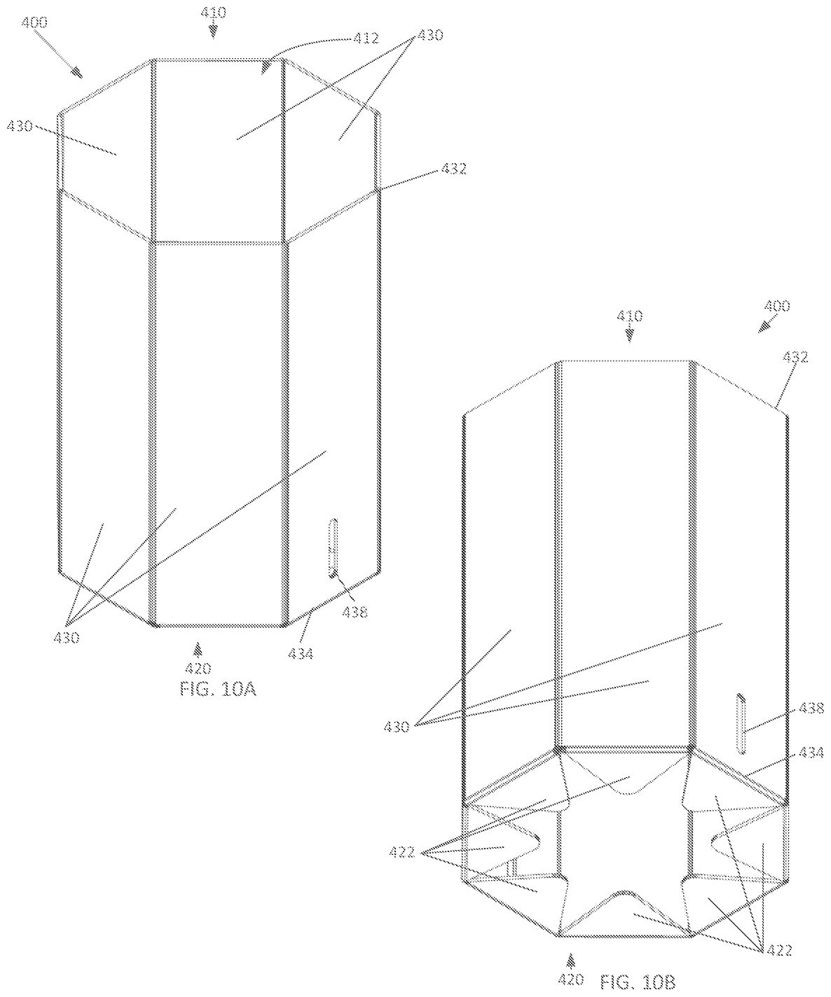

Turning to FIGS. 10A and 10B, illustrated is an embodiment of an inner sleeve 400 of the welding wire container 10. As illustrated in FIGS. 10A and 10B, the inner sleeve 400 may include a top end 410 and an opposite bottom end 420. The inner sleeve 400 may include a series of sidewalls 430 that extend between the top end 410 and the bottom end 420. The inner sleeve 400 may be in the shape of a substantially regular octagonal prism, where each of the sidewalls 430 of the inner sleeve 400 are equal in width. Each of the sidewalls 430 of the inner sleeve may further include a first or top edge 432 and an opposite second or bottom edge 434. As further illustrated in FIGS. 10A and 10B, two of the sidewalls 430 may contain an elongated opening 438 disposed more proximate to the bottom edge 434 than the top edge 432 of the sidewall 430. The elongated openings 438 may be disposed on opposing sidewalls 430 such that the elongated openings 438 may be aligned laterally with one another. The elongated openings 438 of the sidewalls 430 of the inner sleeve 400 may be substantially similar in shape and size to the elongated openings 124, 134 of the first and second panels 105, 106, respectively, of the wide side panels of the outer sleeve 100.

As further illustrated in FIGS. 10A and 10B, the bottom end 420 includes a series of panels 422. While the bottom panels 422 illustrated in FIGS. 10A and 10B are substantially triangular in shape, and do not overlap one another, in other embodiments of the inner sleeve 400, the bottom panels 422 may be of any other shape and may or may not overlap one another. The bottom panels 422 of the bottom end 420 of the inner sleeve 400 may be coupled to the bottom edges 434 of the sidewalls 430. The sidewalls 430 and the bottom panels 422 of the bottom end 420 collectively define an interior cavity 440 of the inner sleeve 400, which may be accessible by the opening 412 in the top end 410 of the inner sleeve 400. Furthermore, the inner sleeve 400 may be constructed from, but not limited to, corrugated fiberboard materials.

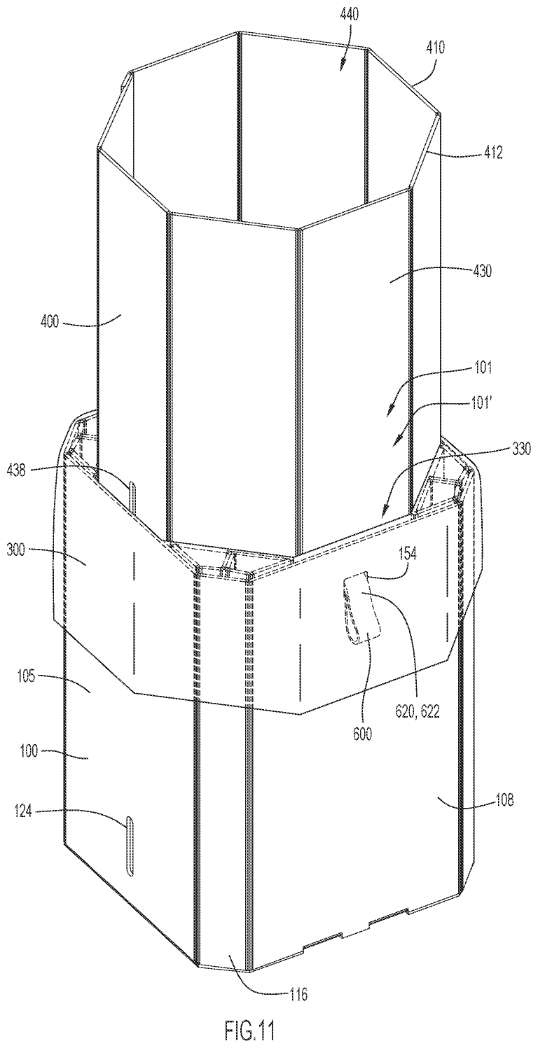

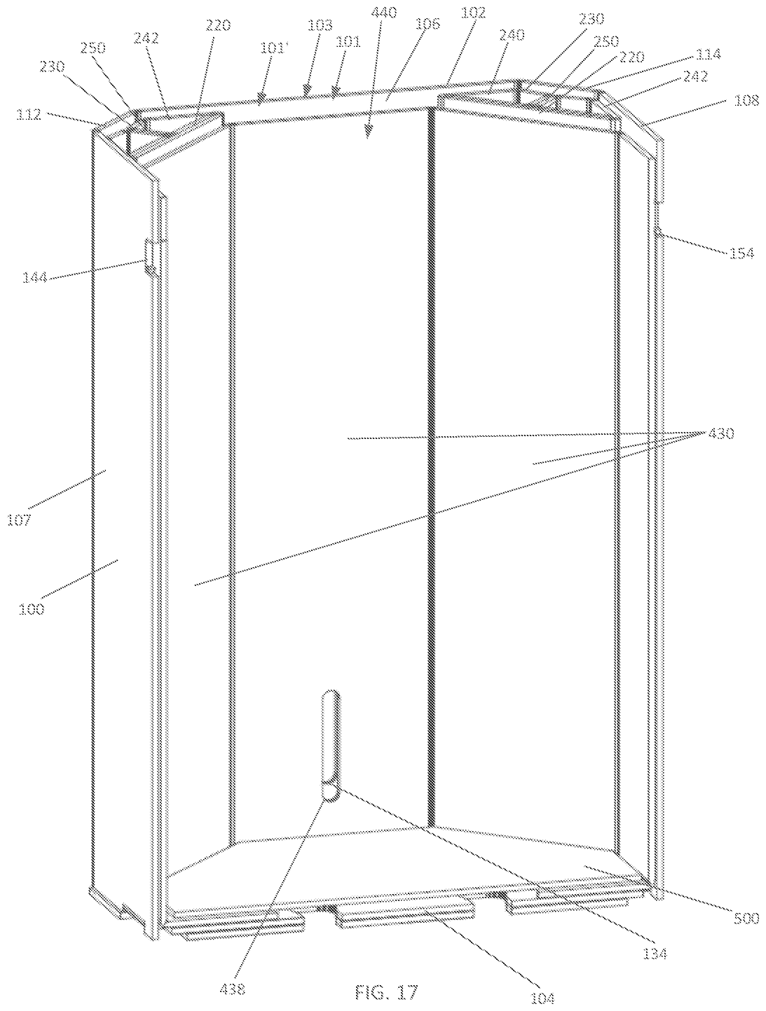

Turning to FIG. 11, illustrated is the inner sleeve 400 being inserted into the sub-region 101′ of the interior cavity 101 of the outer sleeve 100 (via the opening 103 of the top side 102 of the outer sleeve 100), and, in embodiments where the bag 300 is used, into the interior cavity 330 of the bag 300 (via the opening 342 of the top end 340 of the bag 300). As illustrated, in FIG. 11, and further illustrated in FIG. 17 described in more detail below, when the inner sleeve 400 is inserted into the outer sleeve 100, the elongated openings 438 of the inner sleeve 400 may be aligned with the elongated openings 124, 134 of the outer sleeve 100. The alignment of the elongated openings 124, 134, 438 creates an inspection opening or view window into the interior cavity 440 of the inner sleeve 400 (e.g., to determine when the amount of the bulk welding wire coil disposed within the welding wire container 10 is low). In some other embodiments, and while not illustrated, the inner sleeve 400 may differ slightly from that illustrated in FIGS. 10A and 10B in that the inner sleeve 400 may contain multiple tabs disposed proximate to the top edges 432 of the sidewalls 430 (and proximate to the opening 412 in the top end 410) of the inner sleeve 400. The tabs be integrated into the sidewalls 430 of the inner sleeve 400 and may be configured to hold a portion of a welding wire disposed within the interior cavity 440 of the inner sleeve 400 so that it is accessible by the consumer when using the welding wire container 10. The accessible welding wire disposed within the tabs may be used by the consumer to butt weld the end of one welding wire to another welding wire disposed within another welding wire container to create a continuous welding wire system.

Turning to FIGS. 12A-12C, illustrated is a bottom inner panel 500 configured to be inserted into the interior cavity 440 of the inner sleeve 400. FIG. 12A illustrates an exploded view of the bottom inner panel 500, which includes a planar structure 510 and a rod 560. The planar structure 510 includes a top surface 520 and an opposite bottom surface 530, with sides 540. Like that of the inner sleeve 400, the planar structure 510, and thus the bottom inner panel 500, may be in the shape of a regular octagon, where each of the sides 540 of the planar structure 510 are equal in size. The planar structure 510 of the bottom inner panel 500 may be constructed from, but not limited to, corrugated fiberboard materials.

As further illustrated in FIGS. 12A-12C, the planar structure 510 includes a central opening or slot 550 that is disposed in the planar structure 510 such that the slot 550 is equidistant from each of the sides 540. The slot 550 may extend through the planar structure 510 from the top surface 520 to the bottom surface 530. The rod 560 of the bottom inner panel 500 may include a first segment 562, a second segment 564, and an intermediate segment 566. The intermediate segment 566 may be disposed between the first and second segments 562, 564. The first and second segments 562, 564 of the rod 560 may be substantially linear or straight, while the intermediate segment 566 may be bent or in the form of a notch. The rod 560 may be disposed proximate to the bottom surface 530 of the planar structure 510 such that the intermediate segment 566 extends through the central slot 550, and is at least partially extends upwardly from the top surface 520 of the planar structure 510.

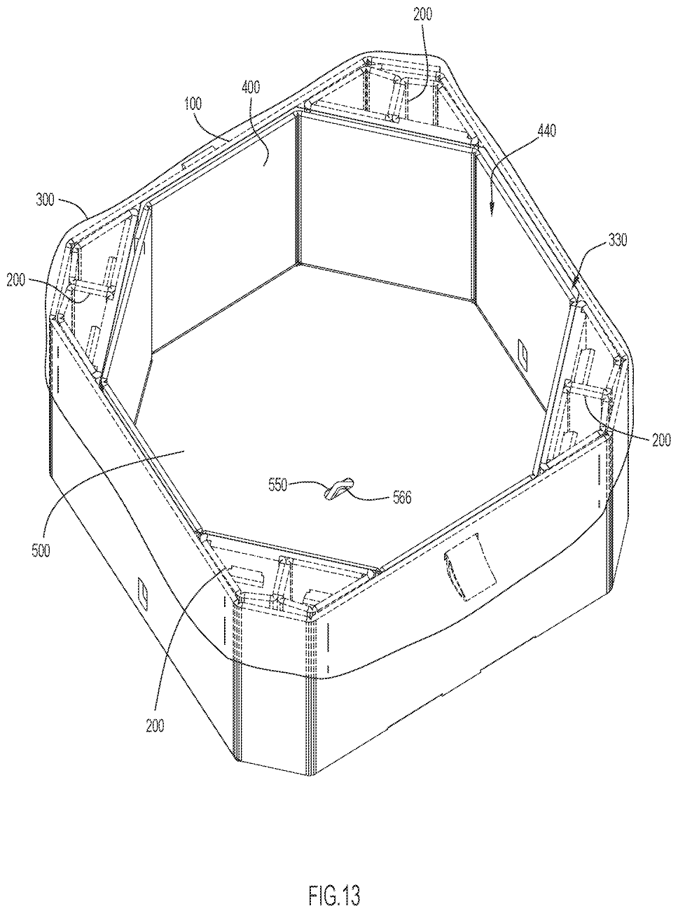

As further illustrated in FIG. 13, the bottom inner panel 500 may be disposed within the interior cavity 440 of the inner sleeve 400 such that the bottom inner panel 500 is disposed proximate to the bottom end 420 of the inner sleeve 400. When disposed within the interior cavity 440 of the inner sleeve 400, the rod 560 is disposed underneath the planar structure 510 of the bottom inner panel 500 such that the intermediate segment 566 of the rod 560 extends upwardly through the central slot 550, and extends upwardly from the top surface of the planar structure 510 of the bottom inner panel 500. As further explained below, when the bulk welding wire coil is disposed within the interior cavity 440 of the inner sleeve 400, the portion of the intermediate segment 566 of the rod 560 of the bottom inner panel 500 may be utilized to secure the bulk welding wire coil within the interior cavity 440 of the inner sleeve 400.

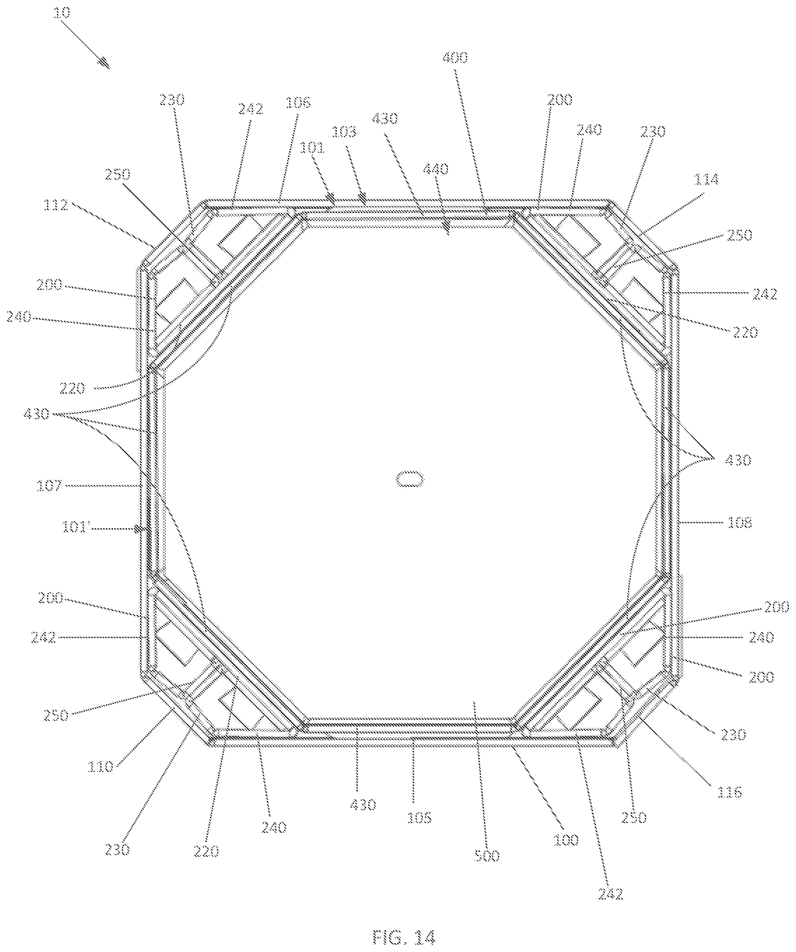

Turning to FIG. 14, as previously explained, while the outer sleeve 100 has a cross-sectional shape of an irregular octagon, when the support members 200 are disposed within the interior cavity 101 of the outer sleeve 100, the resulting sub-region 101′ of the interior cavity 101 (i.e., the sub-region 101′ of the interior cavity 101 is the region of the interior cavity 101 that is not occupied by the support members 200) has a regular octagon shape. When the inner sleeve 400 is disposed within the interior cavity 101 of the outer sleeve 100, the inner sleeve 400 is located in the sub-region 101′ of the interior cavity 101, and the sidewalls 430 of the inner sleeve 400 are in abutment with the first side 220 of each of the support members 200 and the at least a portion of the wide side panels 105, 106, 107, 108. The central ribs 250 of the support members 200 provide structural support to four of the sidewalls 430 of the inner sleeve 400 to prevent those respective sidewalls 430 of the inner sleeve 400 from bowing outward when a bulk welding wire coil is disposed within the interior cavity 440 of the inner sleeve. As further illustrated, the support members 200 and their respective central ribs 250 are substantially equal to the distance between the thin side panels 110, 112, 114, 116 and the respective sidewalls 430 of the inner sleeve 400 such that the sidewalls 430 of the inner sleeve 400 do not bow inwardly when the interior cavity 440 is void of a bulk welding wire coil.

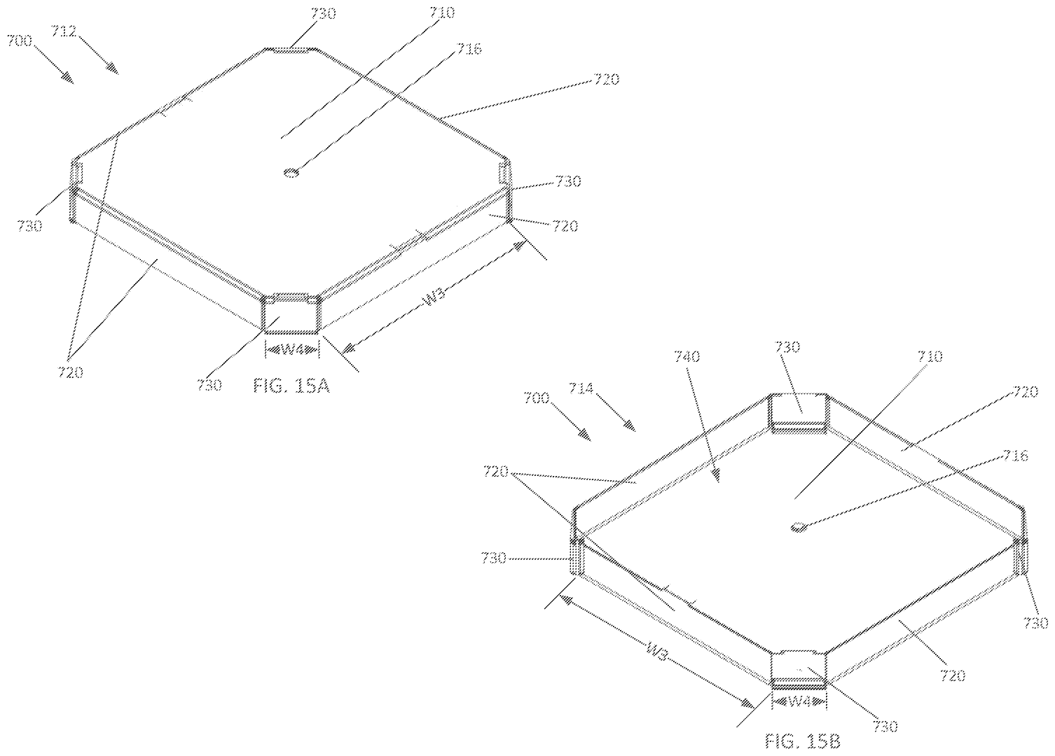

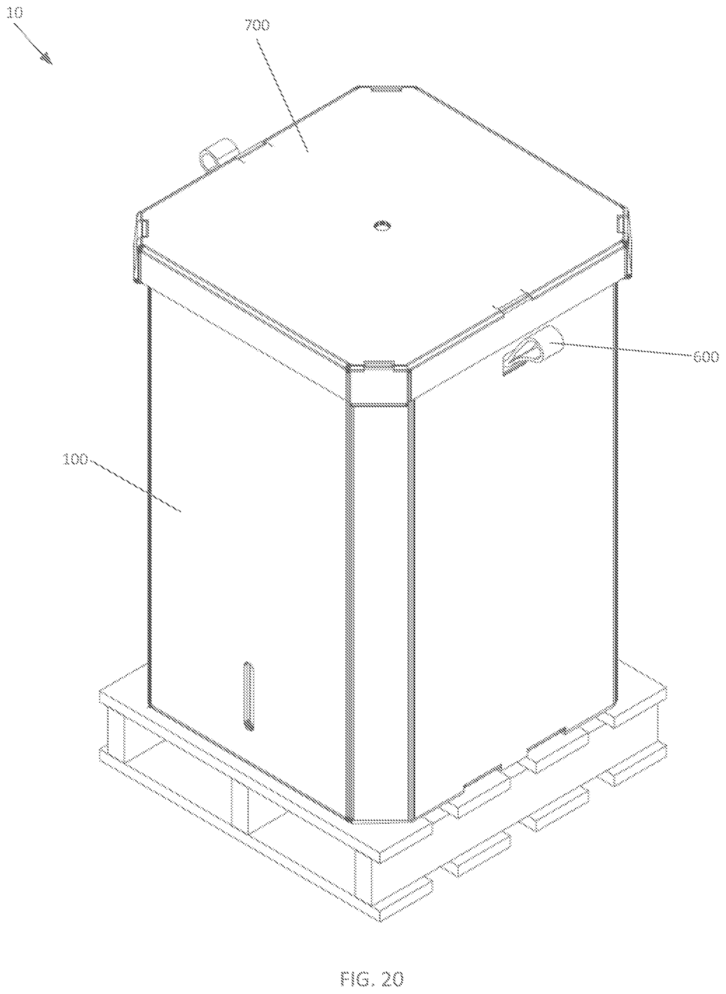

Turning to FIGS. 15A and 15B, illustrated is a lid 700 of the welding wire container 10. Similar to the outer sleeve 100, the lid 700 may in the shape of an irregular octagonal prism that is constructed from, but not limited to, corrugated fiberboard materials. The lid 700 may include a planar panel 710 that has a top or exterior side 712 and an opposite bottom or interior side 714. The lid 700 further includes four wide sidewalls 720 having a first width W3, and four thin sidewalls 730 having a second width W4, where the first width W3 is larger than the second width W4. The first width W3 and the second width W4 may be defined as a measured horizontal distance across a sidewall 720, 730 of the lid 700. The wide sidewalls 720 being wider than the thin sidewalls 730 gives the lid 700 its irregular octagonal prism shape. As illustrated, the wide sidewalls 720 and thin sidewalls 730 are oriented in an alternating pattern around the panel 710 such that a thin sidewall 730 is disposed between two wide sidewalls 720, and vice versa. As best illustrated in FIG. 15B, the wide and thin sidewalls 720, 730 descend from the bottom side 714 of the panel 710 to define a cavity 740. The lid 700 may be disposed atop the welding wire container 10 such that at least a portion of the top side 102 of the outer sleeve 100 is received within cavity 740 of the lid 700 (as illustrated in FIGS. 1C, 1D, and 20). Thus, the lid 700 may be slid over the top side 102 of the outer sleeve 100 so that the lid 700 covers the opening 103 of the outer sleeve 100.

As further illustrated in FIGS. 15A and 15B, the lid 700 may further include a central opening 716 that extends through the panel 710 between the top side 712 and the bottom side 714. The central opening 716 may be configured to facilitate the dispensing of the welding wire disposed within the welding wire container 10 when the lid 700 is disposed on the welding wire container 10. In some embodiments, the central opening 716 may be configured to receive a bearing and/or rotating conduit further configured to dispense the welding wire disposed within the welding wire container 10.

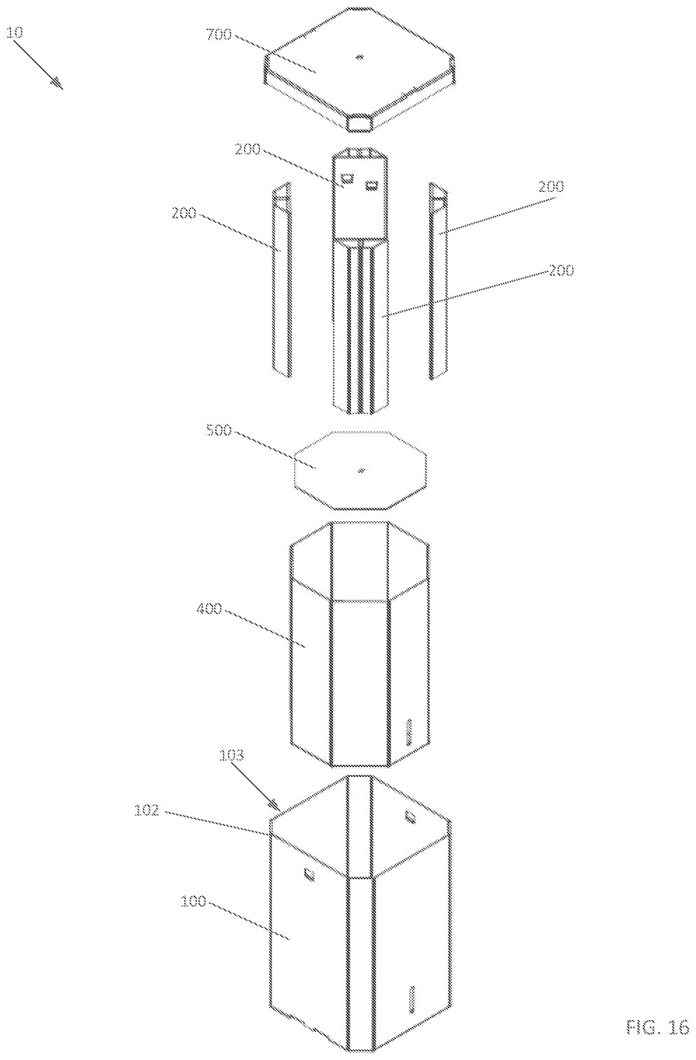

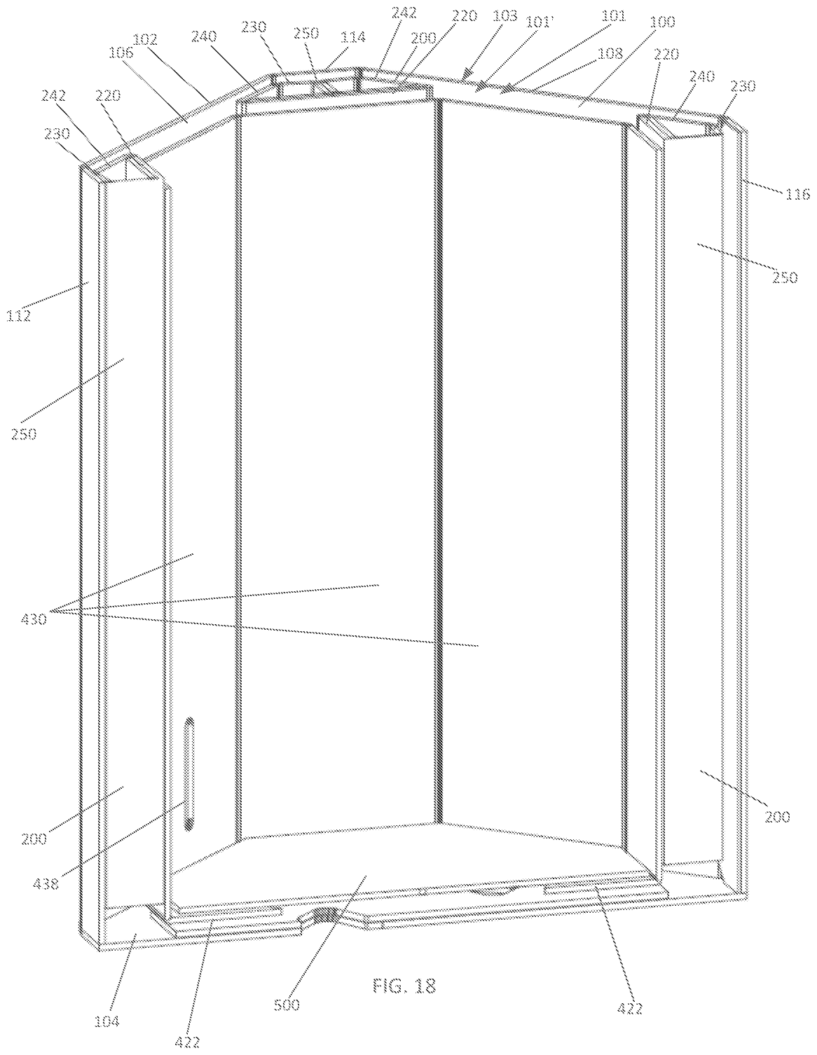

Turning to FIGS. 16, 17, and 18, illustrated is an exploded view of the welding wire container 10 (FIG. 16) and cross-sectional views (FIGS. 17 and 18) of the welding wire container 10. As shown and previously explained, the welding wire container 10 includes an outer sleeve 100 that may be in the shape of an irregular octagonal prism, where the sides of the outer sleeve 100 alternate between wide side panels 105, 106, 107, 108 and thin side panels 110, 112, 114, 116 to create the irregular octagonal prism shape. As previously explained, outer sleeve 100 may contain an opening 103 on the top side 102 that provides access to the interior cavity 101 of the outer sleeve 100. As further illustrated, a plurality of support members 200 may be disposed within the interior cavity 101 of the outer sleeve 100 such that the second side 230 of each support member 200 is disposed against, adjacent to, or proximate to a thin side panel 110, 112, 114, 116 while the third and fourth sides 240, 242 of each support member 200 partially extend along respective wide side panels 105, 106, 107, 108. The combination of the outer sleeve 100 and plurality of support members 200 creates a regular octagonal cross-sectional shaped sub-region 101′ within the interior cavity 101 of the outer sleeve 100 when taken along a horizontal plane that extends through the combination of the outer sleeve 100 and the support members 200.

As further illustrated in FIGS. 17 and 18, the support members 200 do not extend beyond the top side 102 of the outer sleeve 100, and may, extend upwards through the interior cavity 101 of the outer sleeve 100 up to the top side 102. The inner sleeve 400, which may be in the shape of a regular octagonal prism, may be disposed within the interior cavity 101 of the outer sleeve 100 (with or without a bag 300 installed in the interior cavity 101 of the outer sleeve 100) such that the sidewalls 430 of the inner sleeve 400 are in abutment with the first side 220 of each of the support members 200 and the at least a portion of the wide side panels 105, 106, 107, 108 of the outer sleeve 100. As best illustrated in the cross-sectional view illustrated in FIG. 18 (which is the cross-section taken along line Y-Y in FIG. 1A), and as previously explained, the central ribs 250 of the support members 200 are sized such that the central ribs 250 provide structural support to four of the sidewalls 430 of the inner sleeve 400 to prevent those respective sidewalls 430 of the inner sleeve 400 from bowing outward. In addition, the central ribs 250 of the support members 200 are also sized such that they central ribs 250 do not cause the respective sidewalls 430 from bowing inward when the interior cavity 440 of the inner sleeve 100 does not contain a bulk welding wire coil. Moreover, when the inner sleeve 400 is inserted into the outer sleeve 100, the elongated openings 438 of the inner sleeve 400 may be aligned with the elongated openings 124, 134 of the outer sleeve 100 to create an inspection opening or view window into the interior cavity 440 of the inner sleeve 400 (e.g., to determine when the amount of the bulk welding wire coil disposed within the welding wire container 10 is low), which is best illustrated in FIG. 17 (which is the cross-section taken along line X-X in FIG. 1A).

Turning to FIGS. 19A-19C, illustrated is a welding wire container 10 with a bulk welding wire coil 800 disposed within the interior cavity 440 of the inner sleeve 400 of the welding wire container 10 such that the bulk welding wire coil 800 is disposed atop the bottom inner panel 500. The bulk welding wire coil 800 may be formed such that the bulk welding wire coil 800 contains a central passage 810 that extends along the entire length of the bulk welding wire coil 800. As illustrated in FIGS. 19B and 19C, when the bulk welding wire coil 800 is disposed within the interior cavity 440 of the inner sleeve 400, a ring 820 may be disposed atop the bulk welding wire coil 800, atop which a de-coiling cone 830 may be disposed. In some embodiments, the ring 820 may be a corrugated ring. Once the ring 820 and the de-coiling cone 830 are disposed atop the bulk welding wire coil 800, an elastic band 840 may be coupled to the de-coiling cone 830 and may be attached to the intermediate segment 566 of the rod 560 of the bottom inner panel 500 via a hook 850. Thus, as illustrated in FIG. 19C, the elastic band 840 extends through the central passage 810 of the bulk welding wire coil 800, and is coupled to both the de-coiling cone 830 and the intermediate segment 566 of the rod 560 of the bottom inner panel 500. With the arrangement illustrated in FIGS. 19B and 19C, the pressure applied to the top of the bulk welding wire coil 800 by the elastic band 840 via the coupling of elastic band 840 to the de-coiling cone 830 further secures the bulk welding wire coil 800 within the interior cavity 440 of the inner sleeve 400, which prevents the bulk welding wire coil 800 from shifting during transit and use. This arrangement also facilitates efficient de-coiling and distribution of the welding wire as it is unwound from the bulk welding wire coil 800.

As best illustrated in FIG. 20, the welding wire container 10 may be disposed atop a pallet for easy transport and movement of the welding wire container 10. In addition, the handles 612, 622 of the strap 600 that extend out of the outer sleeve 100 may be configured to receive the forks of a forklift to facilitate positioning or repositioning of the welding wire container 10.

Turning to FIGS. 21A and 21B, illustrated is a feed assist unit or hood 900 that is configured to fit the welding wire container 10. The hood 900 may have an exterior surface 902 and an opposite interior surface 904. The hood 900 may further include a base portion 910 and a cone, conical, or dome portion 920. The base portion 910 of the hood 900, similar to the outer sleeve 100 and the lid 700, may have an irregular octagonal cross-sectional shape. The base portion 910 may include a planar panel 911 that has a top or exterior surface 912 and an opposite bottom or interior surface 914 (not shown). The base portion 910 of the hood 900 further includes four wide sidewalls 916 having a first width W5, and four thin sidewalls 918 having a second width W6, where the first width W5 is larger than the second width W6. The first width W5 and the second width W6 may be defined as a measured horizontal distance across a sidewall 916, 918 of the base portion 910 of the hood 900. The wide sidewalls 916 being wider than the thin sidewalls 918 gives the base portion 910 of the hood 900 its irregular octagonal shape. As further illustrated, the wide sidewalls 916 and thin sidewalls 918 are oriented in an alternating pattern around the planar panel 911 of the base portion 910 of the hood 900 such that a thin sidewall 918 is disposed between two wide sidewalls 916, and vice versa. The wide and thin sidewalls 916, 918 descend from the edges of the planar panel 911 of the base portion 910 to at least partially define a cavity 930 with the cone portion 920.

The cone portion 920 of the hood 900 may be centrally disposed on the top surface 912 of the planar panel 911 of the base portion 910 such that the cone portion 920 rises upwardly or vertically from the top surface 912 of the planar panel 911 of the base portion 910. The cone portion 920 may include a first or proximal end 922, which is coupled to the planar panel 911 of the base portion 910, and an opposite second or distal end 924. The cone portion 920 may further include a sidewall 925 that extends between the proximal end 922 and the distal end 924. The cross-sectional diameter of the cone portion 920 decreases from the proximal end 922 to the distal end 924 (i.e., the cross-sectional diameter of the cone portion 920 proximate to the distal end 924 is smaller than the cross-sectional diameter of the cone portion 920 proximate to the proximal end 922). Furthermore, as best illustrated in FIG. 21A, the cone portion 920 may include a view window 926 that is disposed within the sidewall 925. The view window 926 may provide access to the cavity 930 of the hood 900. While not illustrated, in some embodiments, the cone portion 920 may further include a door or access panel that covers the view window 926, and which may be reconfigured between an opened and closed position. In other embodiments, the cone portion 920 may not be equipped with a view window 926, and, instead, may be transparent such that a user may still view inside the cavity 930 of the hood 900. As further illustrated in FIGS. 21A and 21B, the distal end 924 of the cone portion 920 may include a central opening 928. The central opening 928 may be configured to facilitate the dispensing of the welding wire disposed within the welding wire container 10 when the hood 900 is disposed on the welding wire container 10. In some embodiments, the central opening 928 may be configured to receive a bearing and/or rotating conduit further configured to dispense the welding wire disposed within the welding wire container 10.

As best illustrated in FIG. 21C, the hood 900 may be disposed atop the welding wire container 10 such that at least a portion of the top side 102 of the outer sleeve 100 is received within cavity 930 of the hood 900. Thus, the hood 900 may be slid over the top side 102 of the outer sleeve 100 so that the hood 900 covers the opening 103 of the outer sleeve 100. When the hood 900 is disposed on the welding wire container 10, a user may be configured to view the interior cavity 101 of the outer sleeve 100 and the contents disposed within the interior cavity 101. Furthermore, the hood 900 may be constructed from, but not limited to, corrugated fiberboard materials, plastic materials, etc.

The welding wire container 10 disclosed herein may be capable of housing (i.e., during use, transport, and storage) bulk welding wire coils 800 that are larger/heavier compared to the bulk welding wire coiler typically housed by conventional welding wire containers. Conventional welding wire containers may be equipped with or without support members disposed within the corners of the support members. Moreover, the support members of conventional welding wire containers equipped with support members are typically either triangular or circular in shape. The conventional welding wire containers, with or without support members, are typically only capable of housing welding wire coils having a weight of approximately 475 kg. Conversely, the embodiment of the welding wire container 10 disclosed herein is capable of housing welding wire coils having a weight of approximately 500 kg. The welding wire container 10 disclosed herein is capable of housing larger/heavier bulk welding wire coils because of the combination of the irregular octagonal shape of the welding wire container 10 and the trapezoidal prism shaped support members 200. The outer shape of the support members 200, along with the central rib 250 of the support members 200 further aid in the welding wire container 10 disclosed herein being capable of housing larger/heavier bulk welding wire coils compared to conventional welding wire containers. The support members 200 further enable multiple welding wire containers 10 disclosed herein to be stacked atop one another, with or without housing bulk welding wire coils. This enables more efficient and effective storage and transportation of the welding wire containers 10 as multiple welding wire containers 10 may be stacked on top of one another and transported simultaneously.

Furthermore, because the welding wire container 10 is constructed mostly from corrugated fiberboard materials (i.e., at least the outer sleeve 100, the support members 200, the inner sleeve 400, the bottom inner panel 500, and the lid 700 may be constructed from corrugated fiberboard materials), after the bulk welding wire coil 800 disposed within the welding wire container 10 has been consumed, the welding wire container 10 may be recycled. This reduces waste from the welding wire containers 10.

While the welding wire container presented herein have been illustrated and described in detail and with reference to specific embodiments thereof, they are nevertheless not intended to be limited to the details shown, since it will be apparent that various modifications and structural changes may be made therein without departing from the scope of the inventions and within the scope and range of equivalents of the claims.

It is to be understood that terms such as “first,” “second,” “left,” “right,” “top,” “bottom,” “front,” “rear,” “side,” “height,” “length,” “width,” “upper,” “lower,” “interior,” “exterior,” “inner,” “outer” and the like as may be used herein, merely describe points or portions of reference and do not limit the present invention to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the invention. Additionally, it is also to be understood that the welding wire container described herein, or portions thereof may be fabricated from any suitable material or combination of materials.

When used herein, the term “comprises” and its derivations (such as “comprising”, etc.) should not be understood in an excluding sense, that is, these terms should not be interpreted as excluding the possibility that what is described and defined may include further elements, steps, etc. Similarly, where any description recites “a” or “a first” element or the equivalent thereof, such disclosure should be understood to include incorporation of one or more such elements, neither requiring nor excluding two or more such elements. Meanwhile, when used herein, the term “approximately” and terms of its family (such as “approximate”, etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about”, “around”, “generally”, and “substantially.”

Although the disclosed inventions are illustrated and described herein as embodied in one or more specific examples, it is nevertheless not intended to be limited to the details shown, since various modifications and structural changes may be made therein without departing from the scope of the inventions and within the scope and range of equivalents of the claims. In addition, various features from one of the embodiments may be incorporated into another of the embodiments. Thus, the subject matter of the inventions includes all novel and non-obvious combinations and subcombinations of the various elements, features, functions, and/or properties disclosed herein. Accordingly, it is appropriate that the appended claims be construed broadly and in a manner consistent with the scope of the disclosure as set forth in the following claims.

What is claimed is:

1. A container of a welding wire, the container comprising:
an outer sleeve defining an interior cavity; and
at least one support member disposed within the interior cavity of the outer sleeve and extending vertically through the interior cavity of the outer sleeve, wherein the at least one support member is a trapezoidal prism.

2. The container of claim 1, wherein the at least one support member includes a first side, a second side, a third side, and a fourth side, the first side being parallel to the second side, the first side being wider in width than the second side, and the third side and the fourth side connecting the first side to the second side.

3. The container of claim 2, wherein the at least one support member includes a central rib extending between the first side and the second side.

4. The container of claim 2, wherein the outer sleeve has an irregular octagonal prism shape that includes four first sides and four second sides, wherein each of the four first sides are wider than each of the four second sides, and wherein the outer sleeve alternates between first sides and second sides along a perimeter of the outer sleeve.

5. The container of claim 4, wherein the at least one support member is four support members, and wherein each support member of the four support members is disposed within the interior cavity of the outer sleeve such that the second side of each of the four support members is disposed against one of the second sides of the outer sleeve.

6. The container of claim 5, wherein the interior cavity of the outer sleeve is a first interior cavity, the container further comprising:
an inner sleeve disposed within the first interior cavity of the outer sleeve, the inner sleeve defining a second interior cavity.

7. The container of claim 6, wherein the inner sleeve is a regular octagonal prism.

8. A support member for a welding wire container, the support member comprising:
an unfolded orientation, where the support member is planar; and
a folded orientation, where the support member has a trapezoidal prism shape, the support member in the folded orientation comprising:
a first side having a first width;
a second side oriented parallel to and spaced from the first side, the second side having a second width, wherein the first width is greater than the second width;
a third side coupling the first side to the second side; and
a fourth side coupling the first side to the second side, wherein the third and fourth sides are offset from being parallel and from being perpendicular to the first side and the second side.

9. The support member of claim 8, wherein the support member in the unfolded orientation comprises:
a first outer segment;
a second outer segment opposite the first outer segment;
a central segment disposed between the first outer segment and the second outer segment;
a first set of intermediate segments disposed between the first outer segment and the central segment; and
a second set of intermediate segments disposed between the second outer segment and the central segment.

10. The support member of claim 9, wherein the first outer segment includes a first opening and the second outer segment includes a second opening.

11. The support member of claim 10, wherein the central segment includes a first repositionable tab and a second repositionable tab.

12. The support member of claim 11, wherein, when reconfiguring the support member from the unfolded orientation to the folded orientation, the first outer segment is folded along the first set of intermediate segments to be disposed proximate to the central segment such that the first opening of the first outer segment aligns with the first repositionable tab of the central segment.

13. The support member of claim 12, wherein, when reconfiguring the support member from the unfolded orientation to the folded orientation, the second outer segment is folded along the second set of intermediate segments to be disposed proximate to the central segment such that the second opening of the second outer segment aligns with the second repositionable tab of the central segment.

14. The support member of claim 9, wherein the support member is constructed from corrugated fiberboard materials.

15. The support member of claim 9, wherein the support member in the folded orientation further comprises:
a central rib extending between the first side and the second side, the central rib being disposed equidistant from the third side and the fourth side of the support member.

16. The support member of claim 15, wherein the support member in the folded orientation further comprises:
a first tubular channel collectively defined by at least a first portion of the first side, a first portion of the second side, the third side, and the central rib; and
a second tubular channel collectively defined by at least a second portion of the first side, a second portion of the second side, the fourth side, and the central rib.

17. A container configured to house a bulk welding wire coil, the container comprising:
a first sleeve having an irregular octagonal prism shape, the first sleeve defining an interior cavity; and
at least one support member disposed within the interior cavity of the first sleeve and extending vertically through the interior cavity of the first sleeve, the at least one support member being shaped and located within the interior cavity of the first sleeve such that the at least one support member and the first sleeve collectively define a region of the interior cavity of the first sleeve having a regular octagonal shaped cross-section.

18. The container of claim 17, further comprising:
a second sleeve having a regular octagonal prism shape disposed within the region of the interior cavity of the first sleeve.

19. The container of claim 17, wherein the at least one support member is four support members, each of the four support members being a trapezoidal prism.

20. The container of claim 17, wherein the first sleeve and the at least one support member are constructed from corrugated fiberboard materials.
